(19) United States
(12) Patent Application Publication
(10) Pub. No.: US 2024/0362409 A1
(43) Pub. Date: Oct. 31, 2024

(54) Data Insight Generation and Presentation

(71) Applicant: ABI Computing Inc., Newark, DE (US)

(72) Inventor: Johnson Hao Wen Kuan, Azusa, CA (US)

(73) Assignee: ADAPTIVE AI, INC., Newark, DE (US)

(21) Appl. No.: 18/309,802

(22) Filed: Apr. 30, 2023

(51) Int. Cl. G06F 40/186; G06F 16/26; G06N 20/00

(52) U.S. Cl. CPC G06F 40/186; G06F 16/26; G06N 20/00

(57) ABSTRACT

Systems and techniques for insight generation and presentation are described to generate natural language descriptions that describe relationships among data in a database. A user input is processed to determine a data analysis task applicable to the user input and the database. The data analysis task is performed by a machine learning model to retrieve a dataset from the database that is relevant to the user input. The dataset is processed by a machine learning model to generate natural language descriptions, and a presentation page is generated that incorporates the natural language descriptions in order to present insightful data relationships in an easy to consume, natural language format.

### BACKGROUND

With the evolution of Internet and digital technology, more people are consuming a wide variety of online content that can be served to users on a multitude of environments ranging from desktop computers to mobile devices connected to a network. Many everyday tasks in every aspect of life now involve the transmission of data over a network. It is common for businesses or other entities to monitor and track these interactions in order to collect data. This data may be used such as to understand customer behavior, preferences, and needs, which in turn can be leveraged to develop marketing strategies, improve customer engagement, or provide products and services that meet the needs of a target audience. Data collected from consumer interactions can help to identify areas of improvement, such as identifying pain points from a customer's perspective or identifying new product opportunities, to deliver personalized experiences that increase customer loyalty and retention, and so forth. Data collection and analysis can drive modern business strategies and allow businesses to stay competitive while providing superior products and services.

Conventional techniques used to analyze data, however, are faced with numerous challenges that limit accuracy of the techniques, involve inefficient use of computation resources, and requires workers with specialized knowledge and skills to perform the conventional techniques. For example, conventional methods are limited to structured data and struggle to analyze unstructured data. Even with structured data, conventional data analysis methods are time-consuming and require specialized skills to generate data processing pipelines to process structured queries. Changing business needs, or any change to data structure, can require new processing pipelines to be created under conventional techniques, limiting the ability and speed of adapting to changing industry trends or different data sources. Further, with the ever-increasing amount of data being collected every day it is becoming continually more complex, even for an expert, to interpret the vast amounts of data available or even determine which aspects of the data may be useful for analysis. Therefore, these conventional techniques have limited accuracy and adaptability, and result in inefficient use of computational resources by systems that employ these conventional techniques.

### SUMMARY

Systems and techniques for data insight generation and presentation are described to analyze a database, generate insights pertaining to the data in the database, and present the insights in a natural language format. These techniques overcome the limitations of conventional data analysis systems which are limited to manually designed relationships for known database structures. To do so, the insight generation and presentation techniques described herein leverage insights gained from “big data” to generate machine learning models capable of extracting semantic and contextual information from inputs at an extremely high dimensionality, which in turn can learn relationships that go unnoticed by human minds.

A database may be processed along with a user input to determine an intent behind the user input. The intent may be leveraged to generate a text prompt configured for input to a large language model, with the text prompt being formatted and configured to include information relevant to the large language model in responding to the user input. The text prompt may be processed by a large language model to generate code used to extract relevant portions of data from the database, and the code is executed on the database.

The extracted data may be processed to generate another prompt, and this prompt is processed by a large language model to generate natural language descriptions of the extracted data and relationships between different aspects of the extracted data. The extracted data may further be processed to generate a chart that visually represents the extracted data. A template may be selected to display the natural language descriptions and the chart, and a presentation page is generated according to the template to display the natural language descriptions and the chart.

In this way, the data insight generation and presentation techniques may be generalized to a wide range of databases and data formats, without any prior knowledge on the contents of a database. By utilizing machine learning to locate insightful relationships in the data, new insights are discovered compared to conventional techniques by eliminating the need for manually designed processes that target already-known insightful relationships. As a result, systems utilizing the data insight generation and presentation techniques described herein are provided with increased flexibility and utility compared to conventional techniques.

This summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ data insight generation and presentation techniques as described herein.

FIG. 2 depicts an example system showing a task classifier processing pipeline of the digital analytics system of FIG. 1 in greater detail.

FIG. 3 depicts an example system showing a prompt generation model processing pipeline of the digital analytics system of FIG. 1 in greater detail.

FIG. 4 depicts an example system showing a prompt generation processing pipeline of the digital analytics system of FIG. 1 in greater detail.

FIG. 5 depicts an example system showing a data extraction processing pipeline of the digital analytics system of FIG. 1 in greater detail.

FIG. 6 depicts an example user interface of a computing device employing the techniques described herein.

FIG. 7 depicts an example system showing a insight presentation processing pipeline of the digital analytics system of FIG. 1 in greater detail.

FIG. 8 depicts an example system showing a chart generation processing pipeline of the digital analytics system of FIG. 1 in greater detail.

FIG. 9 depicts an example system showing an insight grouping processing pipeline of the digital analytics system of FIG. 1 in greater detail.

FIG. 10 depicts an example system showing a page generation processing pipeline of the digital analytics system of FIG. 1 in greater detail.

FIG. 11 depicts an example scenario with visual examples of data, an insight description, and an insight chart.

FIG. 12 depicts an example topic page.

FIG. 13 depicts an example system showing a machine learning processing pipeline of the digital analytics system of FIG. 1 in greater detail.

FIG. 14 depicts an example environment that employs the techniques of the digital analytics system of FIG. 1.

FIG. 15 depicts an example user interface of a computing device employing the techniques described herein.

FIG. 16 depicts an example user interface of a computing device employing the techniques described herein.

FIG. 17 depicts an example user interface of a computing device employing the techniques described herein.

FIG. 18 is a flow diagram depicting a procedure in an example implementation of data insight generation and presentation techniques.

FIG. 19 illustrates an example system including various components of an example device that can be implemented as any type of computing device as described and/or utilized with reference to FIGS. 1-18 to implement embodiments of the techniques described herein.

### DETAILED DESCRIPTION

### Overview

In conventional systems for data analysis, techniques are derived to confront data with a known structure, and relationships between variables in the data are limited by the knowledge, creativity, and competency of an individual attempting to analyze the data. Such conventional techniques are rigid with respect to data inputs, and insightful relationships between variables in the data can only be identified by a user that already knows the relationships exist, e.g., by specifically creating a processing pipeline that targets the relationship. Thus, conventional techniques not only require expensive manual features designed by data analysis experts, but also have results that are limited by a user's prior knowledge of the data.

Accordingly, data insight generation and presentation techniques are described in which an arbitrary database is analyzed to automatically identify insightful relationships between variables and present the insights in an easy to understand natural language format with context or information that makes the insight readily accessible to a user, regardless of the user's knowledge or skills pertaining to data analysis or the database itself. To do so, the data insight generation and presentation techniques utilize various machine learning models and large language models to process the database along with a user input. The user input, for example, may include a text query indicating a request or asking a question. The user input may be a generalized input that does not include information describing the database. A machine learning model processes the user input and the database to determine a task (e.g., a particular field or type of data analysis) suitable to generate information for use in responding to the user input, and may process the database to understand the semantics and context of fields in the database. In this way, the machine learning model is able to understand an intent behind the user input, choose a task relevant to the user input, and understand the semantics of the database necessary to perform the task. This information may be utilized by a prompt generation engine (e.g., an engine configured to generate prompts optimized for input into a large language model), such as by inputting the user input, task, and semantics into the prompt generation engine and receiving a generated text prompt that is formatted and configured for subsequent input into a large language model.

The large language model may utilize the text prompt to generate code (e.g., SQL code, Python code, and so forth) used to extract a relevant dataset from within the database and to analyze or format the extracted dataset. The dataset may then be input into a prompt generation engine and the resultant prompt input into the large language model to generate natural language insight descriptions that are descriptive of insights contained in the dataset. The dataset may further be processed by a chart generation system to create a visual representation of the insights.

The insight descriptions may be converted into a vector embedding format, and groupings of similar insight descriptions (e.g., insight descriptions that pertain to a similar topic) may be located in a vector embedding space. In this way, the insight descriptions and corresponding insight charts may be segmented and grouped according to their topic. A topic page is created for a topic that conveys information pertaining to the insights associated with the topic, such as by selecting or generating a template suitable for displaying the insight descriptions and charts associated with the topic.

In this way, the data insight generation and presentation techniques may be generalized to a wide range of databases and data formats, without any prior knowledge of the contents of a database. By utilizing machine learning to locate insightful relationships in the data, new insights are discovered compared to conventional techniques by eliminating the need for manually designed processes that target already-known insightful relationships. As a result, systems utilizing the data insight generation and presentation techniques described herein are provided with increased flexibility and utility compared to conventional techniques.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

### Example Environment

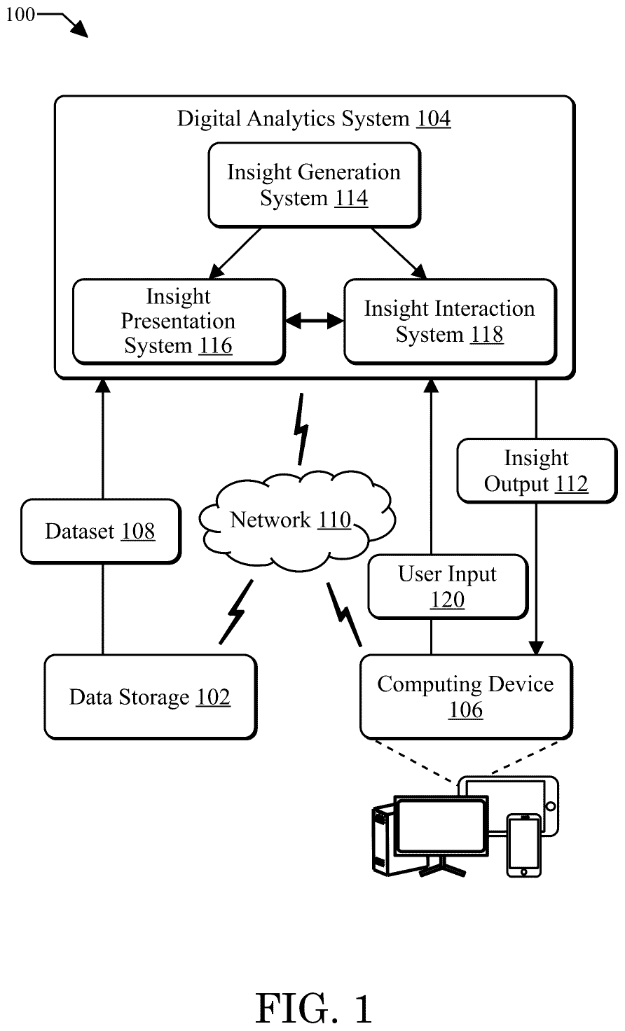

FIG. 1 is an illustration of a digital medium environment 100 in an example implementation that is operable to employ data insight generation and presentation techniques as described herein. The illustrated environment 100 includes a data storage 102, a digital analytics system 104, and a plurality of computing devices, an example of which is illustrated as computing device 106. In this example, the data storage 102 contains a dataset 108 that is communicated to the digital analytics system 104 or accessed by the digital analytics system 104 via a network 110. The data storage 102, the digital analytics system 104, and the computing device 106 are communicatively coupled, one to another, via the network 110 and may each be implemented by a respective computing device that may assume a wide variety of configurations.

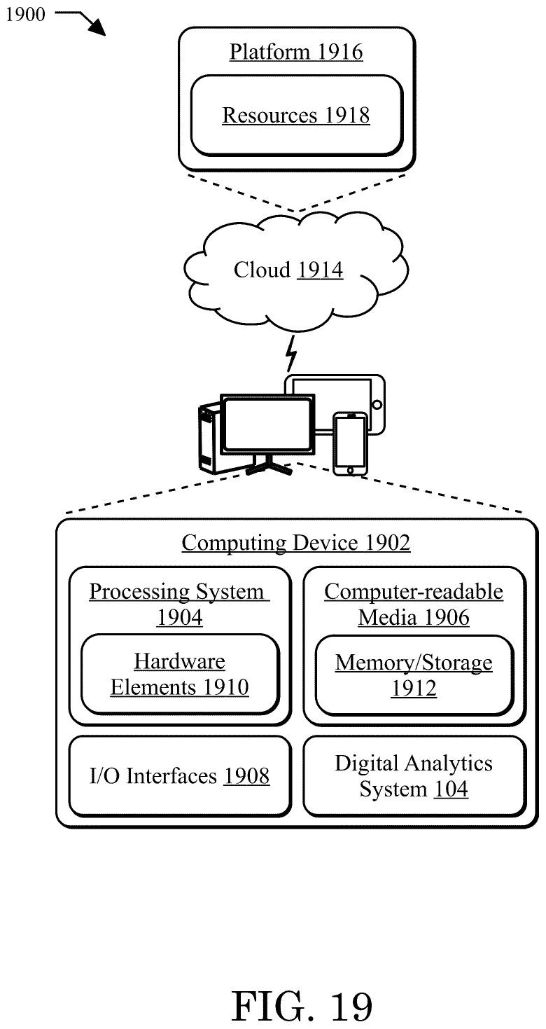

A computing device, for instance, may be configured as a desktop computer, a laptop computer, a mobile device (e.g., with a handheld configuration such as a mobile phone or a tablet, a wearable device such as a watch), a server, and so forth. A computing device may also, for instance, be configured as a network router, a modem, a smart-home device, or any hardware device connected to the network 110. Thus, the computing device may range from full resource devices with substantial memory and processor resources (e.g., servers, personal computers, game consoles) to a low-resource device with limited memory and/or processing resources (e.g., mobile devices, routers). Additionally, although a single computing device is shown, a computing device may be representative of a plurality of different devices, such as multiple servers utilized by a business to perform operations as part of a cloud computing implementation as shown for the digital analytics system 104 as further described in FIG. 19.

The dataset 108 describes data stored in a database. In one example, the dataset 108 includes data collected by a business or organization and can take many forms such as data pertaining to customer information, sales data, financial data, inventory data, employee data, marketing data, website analytics data, supply chain data, production data, social media data, customer service data, risk management data, and so forth. The data storage 102 as illustrated is external to the digital analytics system 104 and the computing device 106, such as a data warehouse or a cloud object storage that contains the dataset 108. In another example, the data storage 102 is included as a part of the digital analytics system 104 or the computing device 106, e.g., as part of a local file system or a local database in the digital analytics system 104 or the computing device 106. Further, the dataset 108 may be generated from various sources, such as by compiling data from multiple databases, by compiling data from multiple data storages 102 or computing devices 106, and so forth.

The dataset 108 is received by the digital analytics system 104, which in the illustrated example employs the dataset 108 to create an insight output 112. To do so, the digital analytics system 104 utilizes an insight generation system 114, an insight presentation system 116, and an insight interaction system 118. The insight generation system 114, for instance, may be used to analyze data within the dataset 108 to find insightful patterns and trends between different variables in the dataset 108. The identified insightful patterns and trends may then be processed by the insight presentation system 116 or the insight interaction system 118 to generate natural language descriptions or other media illustrating or describing the identified insightful patterns and trends as the insight output 112 which is communicated to the computing device 106 via the network 110.

In implementations, the insight output 112 is created responsive to the digital analytics system 104 receiving a user input 120. In one example, the user input 120 includes a user query indicating a question or request pertaining to data in the dataset 108. The digital analytics system 104, for instance, may be hosted on a server and accessed via a website utilizing the network 110. The computing device 106, in this example, accesses the website to display a user interface of the digital analytics system 104 on the computing device 106. A user of the computing device 106 may then interact with the user interface, such as to enter text into an input field of the user interface which is communicated as the user input 120 to the digital analytics system 104 via the network 110. The digital analytics system 104 may then process the user input 120 to generate the insight output 112, and communicate the insight output 112 to the computing device 106 (e.g., to display the insight output 112 in the user interface associated with the website).

The computing device 106, in implementations, generates additional user inputs 120. For instance, a user of the computing device 106 may interact with the insight output 112 displayed on the computing device 106 in order to generate an additional user input 120 indicating changes or alterations to be made to the insight output 112, to request additional insight outputs 112, and so forth. In an example, an additional user input 120 indicates a change to be made to the insight output 112, the digital analytics system 104 utilizes the additional user input 120 and the insight output 112 to create a modified insight output 112 responsive to the additional user input 120, and the digital analytics system 104 communicates the modified insight output 112 to the computing device 106.

The insightful patterns and trends generated by the insight generation system 114 may be utilized by the insight presentation system 116 or the insight interaction system 118. The insight presentation system 116 generates natural language descriptions and other media illustrating or describing the identified insightful patterns and trends. For example, the identified insightful patterns and trends include a collection of numerical data from within the dataset 108, and the insight presentation system 116 generates text descriptions, charts, images, and so forth that present the data with context and information to aid a user in easily consuming and understanding the data. The insight interaction system 118 facilitates interaction with the content generated by the insight generation system 114 or the insight presentation system 116, and may include a user interface to explore and manipulate the data in the dataset 108 and the content generated by the insight generation system 114 or the insight presentation system 116. In an example, the insight interaction system 118 generates charts, pivot tables, and natural language descriptions based on the dataset, code to manipulate the dataset 108 (e.g., SQL code to be run on a machine hosting a database including the dataset 108), and so forth, and presents the content via a user interface for further interaction by a user of the computing device 106. The insight interaction system 118, for instance, generates charts and pivot tables corresponding to the identified insightful patterns and trends, provides mechanisms for interaction with the charts and pivot tables, and generates modified or additional charts and pivot tables responsive to the interaction. In another example, the insight interaction system 118 allows interaction with the content generated by the insight presentation system 116, such as exploration of data or charts included as part of the generated content, exploration of data that is related to the generated content, modification or replacement of parts of the generated content, and so forth.

Conventional techniques for data analysis fail when confronted with unstructured data or evolving or changing data structures. For instance, conventional data analysis techniques require creation of data processing pipelines that process structured queries, with manually curated queries according to a known database structure. Further, conventional data analysis techniques require strong expert knowledge to manually create these data processing pipelines, requiring a time-lag between changes to data structure or new data sources and deployment of a data processing pipeline capable of analyzing the new data sources or structures. As the quantity of data increases, the ability to evaluate available data to manually create a data processing pipeline becomes continually more complex and difficult, causing even experts to be unable to understand the data well enough to create effective data processing pipelines. These conventional data analysis techniques are thus time-consuming and expensive, often requiring a dedicated data analysis team tailored to support a single organization or entity, and impose strict requirements on data format and storage.

Accordingly, as described herein, data insight generation and presentation techniques are implemented to leverage machine learning or artificial intelligence to identify insights within a dataset and transform the insights into formats easily consumable by human users, and without any prior knowledge or identification of data structure, format, or sources. These techniques allow for real-time or near real-time analysis of a wide range of datasets with unknown contents, which is not possible using conventional data analysis techniques. To do so, the data insight generation and presentation techniques described herein utilize an insight generation system to interpret data in a dataset and generate insights based on the dataset. The insights are processed by an insight presentation system to summarize the insights into natural language or visual formats for consumption by a user. An insight interaction system allows for interaction with and exploration of the insights and the data. In this way, the data insight generation and presentation techniques described herein overcome the limitations of conventional techniques, and thus enhance data analysis (i.e., increased flexibility in data input, leveraging machine learning to identify patterns and trends that are not apparent using traditional data analysis methods, and so forth) and provide an improved user experience (i.e., allowing for inputs crafted without specialized knowledge or skills pertaining to data analysis, real-time or near real-time responsiveness to data input or structure, flexibility for a user to select, interpret, or modify the generated insights, and so forth) on computing devices that employ these techniques.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

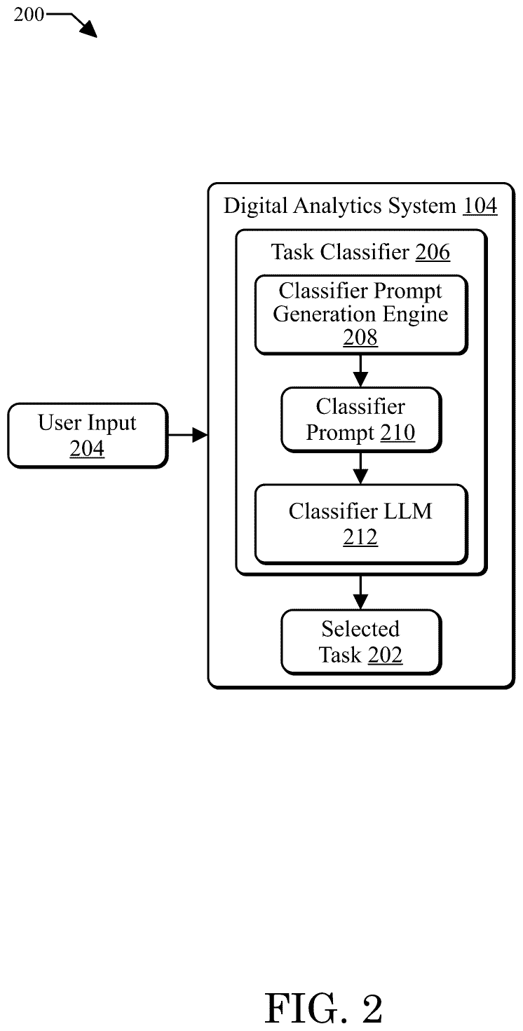

FIG. 2 depicts a system 200 showing an example task classifier processing pipeline of the digital analytics system 104 of FIG. 1 in greater detail to create a selected task 202 associated with a user input 204. The task classifier processing pipeline begins with the user input 204 being input to a task classifier 206. In implementations, the task classifier 206 is included as part of the insight generation system 114.

The user input 204, in implementations, includes a text query input by a user (e.g., a user of the computing device 106 of FIG. 1). As an example, the user input 204 includes a question “what is the churn rate of customers with fiber internet?”, which was input in a user interface on the computing device 106 and communicated via a network to the digital analytics system 104. The task classifier 206 employs a classifier prompt generation engine 208 to generate a classifier prompt 210 based on the user input 204, and the classifier prompt 210 is input to a classifier Large Language Model (“LLM”) 212. A Large Language Model is a model of the probability distribution over sequences of text, such as a deep learning neural network model that is pretrained on a large amount of text to understand written language. The classifier LLM 212 processes the classifier prompt 210 to generate the selected task 202 associated with the user input 204. The task classifier 206, through use of the classifier prompt generation engine 208 and the classifier LLM 212, determines an expected user intent associated with the user input 204 and generates the selected task 202 to enable an appropriate data analysis associated with the user input 204.

The selected task 202, for instance, may be one of descriptive analytics (e.g., generating metrics and reports describing the state of a business associated with the data), predictive analytics (e.g., training machine learning models to make predictions, such as propensity modeling and so forth), prescriptive analytics (e.g., training models that give recommendations on next-best-action for a business to take), cluster analysis (e.g., using machine learning to find groupings in the data, such as segmentation and so forth), correlation or association analysis (e.g., measuring association between variables), causal interference analysis (e.g., estimating causal effects), and so forth. The selected task 202 generated by the task classifier 206 is associated with the user input 204 and guides further processing by the digital analytics system 104 that is associated with the user input 204, such as by providing additional input to the insight generation system 114, insight presentation system 116, or insight interaction system 118 in order to create the insight output 112 of FIG. 1.

In the above example with a user input 204 of “what is the churn rate of customers with fiber internet?”, the task classifier 206 may generate a selected task 202 of “descriptive analytics”, and the insight generation system 114, the insight presentation system 116, or the insight interaction system 118 perform processes associated with descriptive analytics to describe historical data. As another example, the task classifier 206 may receive a user input 204 of “predict the churn rate of customers with fiber internet” and generate a selected task 202 of “propensity modeling predictive analytics”, and the insight generation system 114, the insight presentation system 116, or the insight interaction system 118 perform processes associated with propensity modeling and predictive analytics to generate predicted future data. As yet another example, the task classifier 206 may receive a user input 204 of “how can we lower the churn rate of customers with fiber internet” and generate a selected task 202 of “prescriptive analytics”, and the insight generation system 114, the insight presentation system 116, or the insight interaction system 118 perform processes associated with prescriptive analytics to generate recommendations on actions the user can take. In this way, the task classifier 206 processes a user input to understand an intent of the user input, and uses the intent to generate an appropriate data analysis task in relation to the user input.

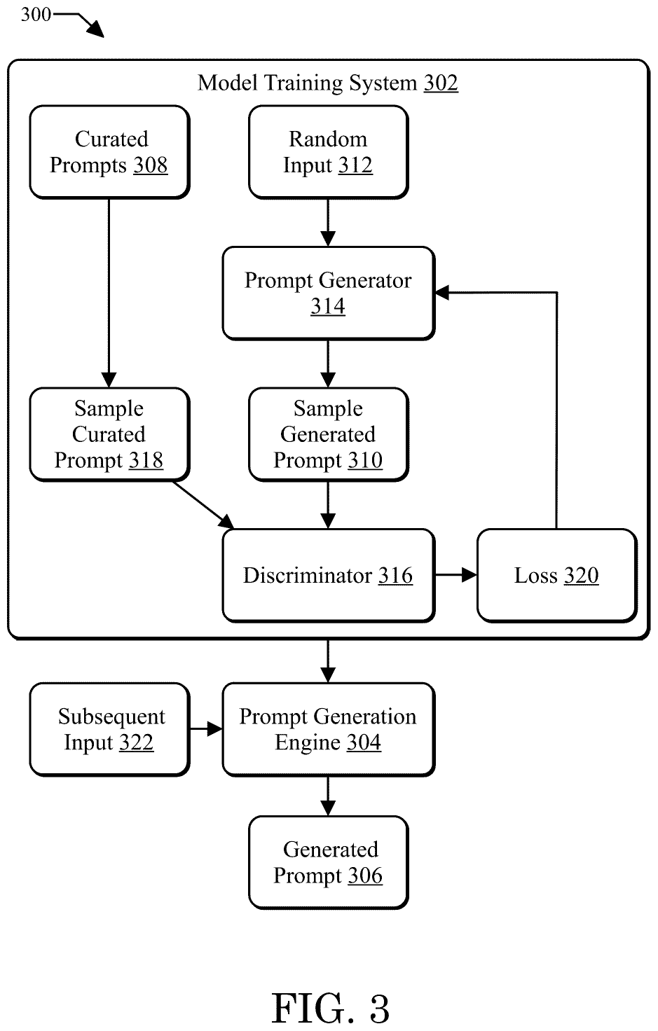

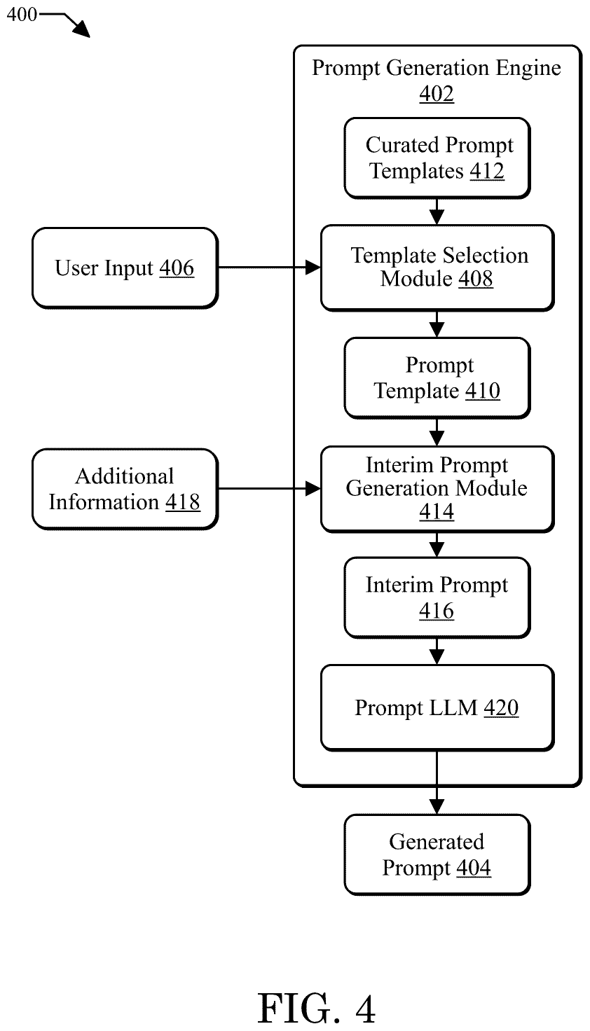

The classifier prompt generation engine 208 transforms the user input 204 into a classifier prompt 210 that is suitable for input into the classifier LLM 212. For instance, the classifier prompt generation engine 208 receives an arbitrary user input 204, determines relevant information within the user input 204, removes irrelevant information from the user input 204, adds additional contextual or semantic information, and so forth to create the classifier prompt 210. The classifier prompt generation engine 208 is created or trained, for example, using a technique described in additional detail with respect to FIG. 3 or using a technique described in additional detail with respect to FIG. 4.

The classifier LLM 212 is a trained machine learning model configured to receive the classifier prompt 210 and generate the selected task 202. In implementations, the classifier LLM 212 generates a selected task 202 to be utilized in responding to the user input 204 without generating a response to the user input 204. The classifier LLM 212, for instance, may be created from a generative machine learning model that utilizes machine learning algorithms to understand underlying structures of sample input data and generate, for a subsequent input, new data that has structures similar to the training data. For example, the classifier LLM 212 is created by using a generative machine learning model (e.g., a generative adversarial network, a variational autoencoder, an autoregressive model, and so forth) that learns the structure of language in manually curated prompts for input to an LLM that are created with specialized skill and knowledge by a machine learning expert, in order to learn the ability to generate prompts for arbitrary inputs that are structurally similar to the manually curated prompts.

FIG. 3 depicts a system 300 showing an example prompt generation model processing pipeline of a model training system 302 to create a prompt generation engine 304 which creates a generated prompt 306. For example, the prompt generation engine 304 and the generated prompt 306 may respectively correspond to the classifier prompt generation engine 208 and the classifier prompt 210 of FIG. 2.

The prompt generation model processing pipeline begins with the creation of curated prompts 308. The curated prompts 308 are, for instance, manually created by an expert in the field of machine learning and large language models, and are designed to be optimal prompt inputs into an LLM. Randomly generated prompts are created, an example of which is illustrated as sample generated prompt 310, by inputting a random input 312 into a prompt generator 314. The sample generated prompt 310 is input to a discriminator 316 along with a sample curated prompt 318 (e.g., a prompt from among the curated prompts 308).

The discriminator 316 is configured as a classifier to distinguish between curated prompts and generated prompts, and accordingly classifies the sample generated prompt 310 and the sample curated prompt 318 based on whether it determines the respective prompts to be curated or generated. A measure of loss 320 is created that reflects the accuracy of discriminator 316 in its classification of the sample generated prompt 310 and the sample curated prompt 318, and this process may be repeated many times with any number of different sample generated prompts 310 and sample curated prompts 318. The loss 320 is backpropagated to the prompt generator 314 to change parameters or weights of the prompt generator 314, with a goal of maximizing the loss 320 (e.g., as similarity between the generated and curated prompts increases, the discriminator will have greater difficulty in correctly classifying the input prompts, indicating a greater accuracy of the prompt generator 314 in creating generated prompts). This process is repeated until the parameters of the prompt generator 314 are capable of creating sample generated prompts 310 nearly indistinguishable from the sample curated prompts 318 when input to the discriminator 316.

Although described above as utilizing a generative adversarial network, the model training system 302 may generate the prompt generation engine 304 using any suitable machine learning techniques. According to various implementations, the model training system 302 uses generative machine learning, an encoder-decoder architecture, supervised learning, unsupervised learning, reinforcement learning, and so forth. For example, the model training system 302 can include, but is not limited to, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. In any case, the model training system 302 uses machine learning techniques to continually train and update the prompt generator 314 to produce accurate prompts given a subsequent input.

Once the model training system 302 has completed iteratively refining and changing parameters of the prompt generator 314, the prompt generator 314 is output from the model training system 302 with the final variation of parameters as the prompt generation engine 304 (e.g., the classifier prompt generation engine 208 of FIG. 2). The prompt generation engine 304 is configured to receive a subsequent input 322 (e.g., the user input 204 of FIG. 2) and generate a prompt 306 (e.g., the classifier prompt 210 of FIG. 2), such as for input into an LLM (e.g., the classifier LLM 212 of FIG. 2).

FIG. 4 depicts a system 400 showing an example prompt generation processing pipeline of a prompt generation engine 402 to create a generated prompt 404. For example, the prompt generation engine 402 and the generated prompt 404 may respectively correspond to the classifier prompt generation engine 208 and the classifier prompt 210 of FIG. 2.

The prompt generation processing pipeline begins with a user input 406 (e.g., the user input 204 of FIG. 2) being input into a template selection module 408. The user input 406, for instance, may include a prompt, and thus the prompt generation engine 402 is capable of using a prompt (e.g., the user input 406) to generate a different prompt (e.g., the generated prompt 404). The template selection module 408 selects a prompt template 410 from among multiple curated prompt templates 412, such as by searching the curated prompt templates 412 for a template that is best suited for the user input 406.

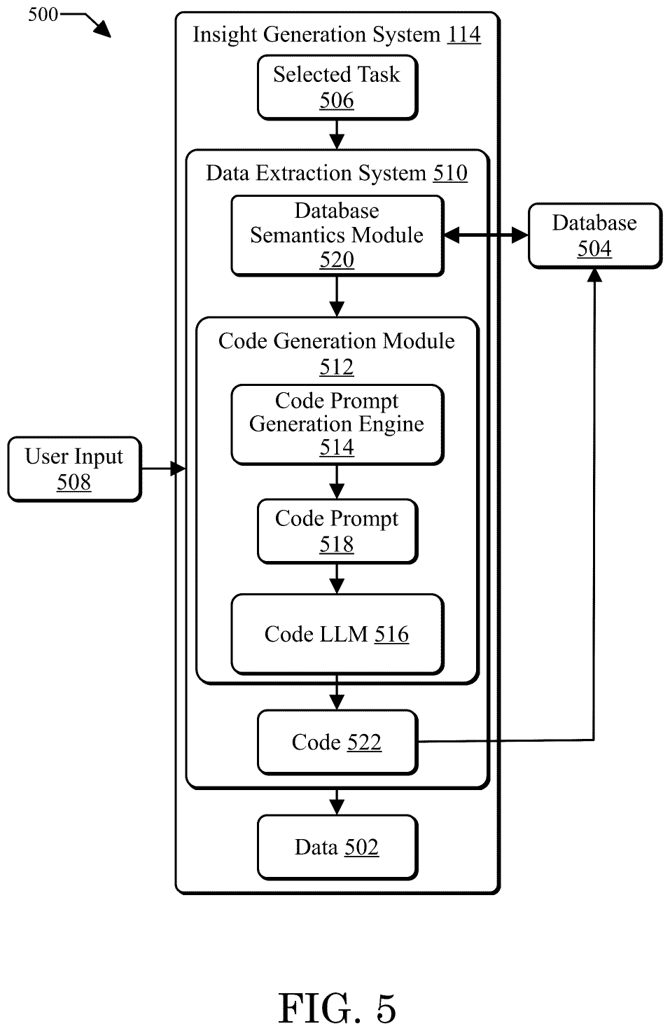

The prompt template 410 is processed by an interim prompt generation module 414 to generate an interim prompt 416 based on the prompt template 410. The interim prompt generation module 414 populates the prompt template 410 with the user input 406. In implementations, the interim prompt generation module 414 may additional populate the prompt template 410 with additional information 418. The additional information 418, for example, includes database semantic information, metadata, and so forth. For instance, database semantic information may be received such as described below with respect to FIG. 5.

The interim prompt 416 is input into a prompt LLM 420. The prompt LLM 420 is a trained machine learning model configured to receive an input prompt (e.g., the interim prompt 416) and generate another prompt for output (e.g., the generated prompt 404), such as to refine or rephrase text within the input prompt, remove extraneous information within the input prompt, and so forth. The output prompt is configured to be used as input into an LLM. The prompt LLM 420, for instance, may be created from machine learning algorithms to understand underlying structures of sample input data and generate, for a subsequent input, new data that has structures similar to the training data. For example, the prompt LLM 420 may be created by using a generative machine learning model (e.g., a generative adversarial network, a variational autoencoder, an autoregressive model, and so forth) that learns the structure of language in order to learn the ability to generate optimized prompts based on an input.

In an example, the user input 406 includes a text query of “what is the churn rate of customers with fiber internet” that is input to the prompt generation engine 402. The template selection module 408 processes the text query in the user input 406 to select a prompt template 410 that includes: “Given business question and database semantic information, reframe the question as precise and relevant instructions to write code to pull data. Database semantic/metadata information: [insert table names, column names, types, metadata such as description of columns]. Question: [insert query from human].” The interim prompt generation module 414 generates the interim prompt 416 by modifying the prompt template 410 to incorporate the user input 406 and the additional information 418, such that the interim prompt 416 includes: “Given business question and database semantic information, reframe the question as precise and relevant instructions to write code to pull data. Database semantic/metadata information: Tables in database: customer_dim, . . . , customer_dim columns: acct_id, . . . , acct_id description: . . . , . . . , Question: What is the churn rate of customers with fiber internet?”.

The prompt generation engine 402 inputs the interim prompt 416 into the prompt LLM 420 to generate the generated prompt 404. In the ongoing example, for instance, the generated prompt 404 output by the prompt LLM 420 includes: “generate SQL code to extract an average monthly count from customer_monthly where internet_product_type=‘fiber’ for each of entities that are current customers and entities that are not current customers.” In this way, the prompt generation engine 402 receives an arbitrary user input 406 and outputs a generated prompt 404 that includes relevant information from the user input 406 along with additional contextual or semantic information.

FIG. 5 depicts a system 500 showing an example data extraction processing pipeline of the insight generation system 114 of FIG. 1 in greater detail to extract data 502 from within a database 504. The data extraction processing pipeline begins with a selected task 506 (e.g., the selected task 202 of FIG. 2) along with a user input 508 (e.g., the user input 204 of FIG. 2) being input into a data extraction system 510 of the insight generation system 114.

The selected task 506 determines a configuration of the data extraction system 510 with respect to the user input 508. For instance, the data extraction system 510 may select a code generation module 512, from among multiple possible code generation modules, that includes a respective code prompt generation engine 514 and code LLM 516 that are tailored for the particular selected task 506. For example, a first code generation module 512 corresponding to a selected task 506 of “descriptive analytics” includes a first code prompt generation engine 514 and code LLM 516 that are each created or trained to optimize tasks pertaining to descriptive analytics, while a second code generation module 512 corresponding to a selected task 506 of “causal inference analysis” includes a second code prompt generation engine 514 and code LLM 516 that are each created or trained to optimize tasks pertaining to causal inference analysis. In other implementations, the code generation module 512 is trained to accommodate all types of tasks, and the selected task 506 is included as an input to the code prompt generation engine 514.

The data extraction system 510 inputs the user input 508 into the code generation module 512. The code prompt generation engine 514 generates a code prompt 518 corresponding to the user input 508, and the code prompt 518 is input into the code LLM 516. The code prompt generation engine 514 or the code LLM 516 may employ a database semantics module 520 to understand the semantics and context of fields in the database 504. The user input 508 and the code generation module 512, for instance, may not include any knowledge or structure of the database 504. In this way, the code generation module 512 may operate on any arbitrary database 504 with an arbitrary structure and labels. The database semantics module 520 may employ a LLM or other trained machine learning model to understand the semantics of the database 504, such as by the database semantics module 520 querying the database 504 for table headers and processing the table headers with a LLM to generate context for the table headers.

For example, the user input 508 may include text “what is the churn rate of customers with fiber internet?”, yet the database 504 does not include “churn rate” or data labeled as “customers with fiber internet”. In this example, the database semantics module 520 processes the database 504 to identify data that may be relevant to the user input 508, and through use of a machine learning module the database semantics module 520 locates data associated with an “internet_product_type” field in a “customer_monthly” table, and adds contextual information that these fields correspond to customer internet types. The database semantics module 520 thus allows contextual and semantic information to be learned or generated in order to understand data in an arbitrary database 504.

The code generation module 512 utilizes the user input 508 in conjunction with knowledge gained from the database semantics module 520 in order to generate a code prompt 518 tailored specifically for the particular database 504. The code prompt generation engine 514, for instance, is generated or trained as the prompt generation engine 304 of FIG. 3 or the prompt generation engine 402 of FIG. 4 as described above, using curated prompts or curated prompt templates that are curated specifically for the desired code prompt generation engine 514.

The code LLM 516 is a trained machine learning model configured to receive a code prompt 518 and generate code 522. In implementations, the code LLM 516 generates code 522 to be utilized in accessing or manipulating the database 504 in a manner corresponding to the user input 508. The code LLM 516 is a machine learning model that uses deep learning techniques to process and generate natural language text. An example code LLM 516 is a generative pre-trained transformer, which uses a deep neural network architecture composed of multiple layers that can learn to represent the contextual relationships between words, and is trained to predict a next word or sequence of words in text. However, the code LLM 516 may be a natural language processing model created from any suitable type of machine learning, such as generative machine learning, an encoder-decoder architecture, supervised learning, unsupervised learning, reinforcement learning, and so forth. For example, the code LLM 516 may be generated with, but is not limited to, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc.

In the ongoing example with a user input 508 of “what is the churn rate of customers with fiber internet?”, a selected task 506 is generated (e.g., as described above with respect to FIG. 2) as “descriptive analytics”, and the code prompt generation engine 514 utilizes the database semantics module 520 to identify portions of the database 504 that may pertain to the user input 508, including data associated with an “internet_product_type” field in a “customer_monthly” table. The code prompt generation engine 514 incorporates the knowledge gained from the database semantics module 520 in generating the code prompt 518. For example, the user input 508 of “what is the churn rate of customers with fiber internet?” is transformed into a code prompt 518 of “generate SQL code to extract an average monthly count from customer_monthly where internet_product_type=‘fiber’ for each of entities that are current customers and entities that are not current customers.” The code prompt 518 is then input to the code LLM 516, which generates the code 522 to be applied upon the database 504. The data extraction system 510 executes the code 522 on the database 504 to extract the data 502. The code 522 includes any suitable code for responding to the user input 508, and may include code that does not execute upon the database 504. For example, SQL code executed upon the database 504 may return a value of “2.28%”, and the code 522 includes additional code to reformat or add structure or context to the returned value, such that the data 502 may include “The churn rate of customers with fiber internet is 2.28%.”

In implementations, the code 522 includes multiple different portions of code, and may include portions of code corresponding to different respective programming languages and for different respective purposes. For instance, the code 522 may include a first portion of code to retrieve the data 502 from the database 504 (e.g., code configured to be executed with respect to the database 504 in a language such as in a SQL, PHP, Python, R, C#, and so forth), and a second portion of code to perform data processing, data analysis, model training, and so forth (e.g., code configured to be executed on the computing device 106 or the digital analytics system 104 in a language such as Python, Java, JavaScript, Scala, C, C++, C#, Julia, and so forth). The code generation module 512 may determine an appropriate programming language for each respective portion of the code 522 that is best suited to respond to the selected task 506 and the user input 508.

Further, portions of the code 522 may be exposed directly to a user of the insight generation system 114, such as by displaying the code 522 in a user interface on the computing device 106. By exposing the code 522 to a user prior to execution, a user of the insight generation system 114 may verify that the code 522 will not adversely affect the integrity or security of the database 504, may apply the code 522 against a database different than the database 504, may modify the code 522 to operate differently than as designed by the code LLM 516, and so forth.

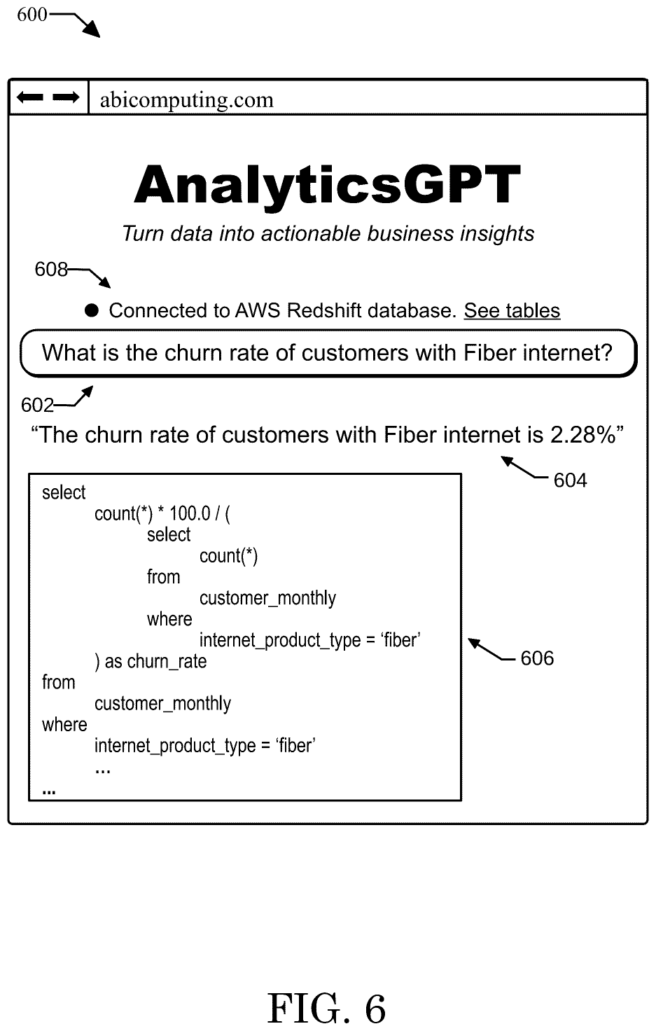

FIG. 6 illustrates an example scenario 600 depicting an example user interface on a client device. For instance, the example user interface is displayed within an internet browser on a computing device, and includes an interactive text field 602 where a user of the computing device may input text (e.g., as the user input 508 of FIG. 5). The website is configured to communicate the input text to the insight generation system 114, which in this example has returned to the computing device both a natural language answer 604 and the SQL code 606 that was generated and utilized by the insight generation system 114 to retrieve the data used to create the natural language answer 604. In this example, the example user interface further includes a button 608 that displays a currently selected database (e.g., the database 504) and allows input to select a database (e.g., an initial selection or the change the current selection) against which the user input is processed.

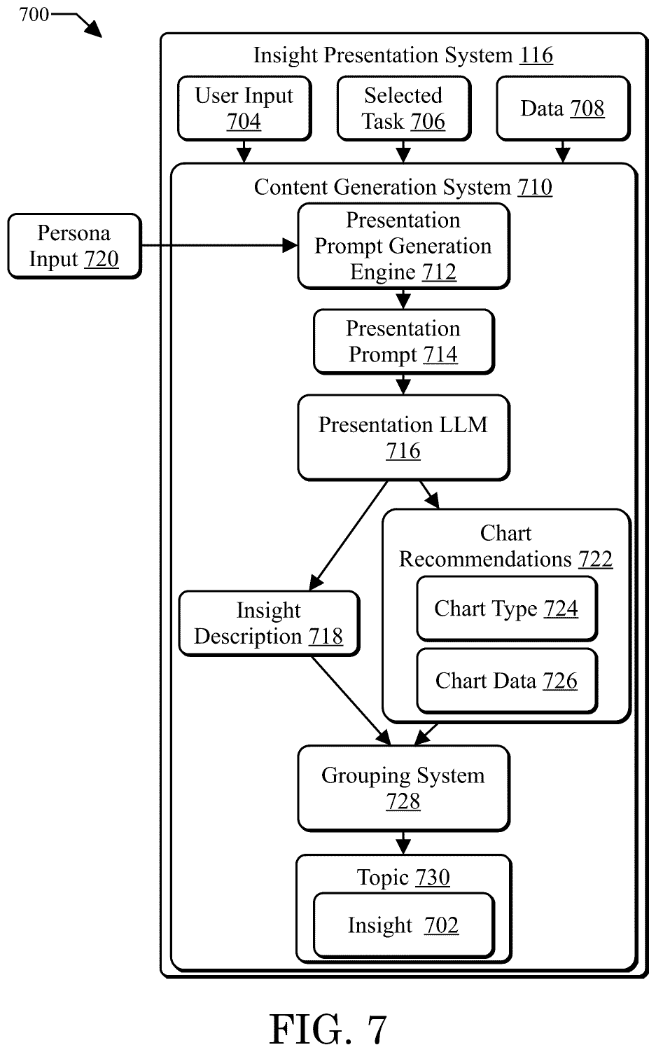

FIG. 7 depicts a system 700 showing an example insight presentation processing pipeline of the insight presentation system 116 of FIG. 1 in greater detail to generate an insight 702 for presentation. The insight generation processing pipeline begins with a user input 704 (e.g., the user input 508 of FIG. 5), a selected task 706 (e.g., the selected task 506 of FIG. 5), and data 708 (e.g., the data 502 of FIG. 5) being input into a content generation system 710 of the insight presentation system 116.

The content generation system 710 provides the user input 704, the selected task 706, and the data 708 as input to a presentation prompt generation engine 712. The presentation prompt generation engine 712 processes the inputs to generate a presentation prompt 714 corresponding to the inputs. The presentation prompt generation engine 712, for instance, is generated or trained as the prompt generation engine 304 of FIG. 3 or the prompt generation engine 402 of FIG. 4 as described above, using curated prompts or curated prompt templates that are curated specifically for the desired presentation prompt generation engine 712 such that the presentation prompts 714 are optimized for input into a presentation LLM 716.

The presentation LLM 716 is a trained machine learning model configured to receive a presentation prompt 714 and generate an insight description 718. In implementations, The insight description 718 presents insights learned from the data 708 in a natural language format with context allowing the data insights to be easily consumed by a user. The presentation LLM 716 is a machine learning model that uses deep learning techniques to process and generate natural language text. An example presentation LLM 716 is a generative pre-trained transformer, which uses a deep neural network architecture composed of multiple layers that can learn to represent the contextual relationships between words, and is trained to predict a next word or sequence of words in text.

However, the presentation LLM 716 may be a natural language processing model created from any suitable type of machine learning, such as generative machine learning, an encoder-decoder architecture, supervised learning, unsupervised learning, reinforcement learning, and so forth. For example, the presentation LLM 716 may be generated with, but is not limited to, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc.

In implementations, the content generation system 710 inputs a persona input 720 as a further input to the presentation prompt generation engine 712. The persona input 720, in implementations, is selected in a user interface of the computing device 106 from a list of available personas for the insight presentation system 116, e.g., by selecting the persona input 720 from a drop-down list of personas. The persona input 720 affects the style and tone of the output of the presentation LLM 716. In one example, the persona input 720 is incorporated by the presentation prompt generation engine 712 into the presentation prompt 714, e.g., such that the presentation prompt 714 indicates a persona associated with the persona input 720. In another example, the persona input 720 is used by the content generation system 710 to select a particular presentation LLM 716 from among multiple available presentation LLM's, with the particular presentation LLM 716 having been trained according to the persona associated with the persona input 720.

Two example scenarios are described below to illustrate these personas. In both example scenarios, the presentation LLM 716 is tasked with performing a correlation analysis on variables of customer contract type and whether the customer has internet, understanding the relationship between the variables, and generating insight descriptions 718 that pertain to the data 708 and describe aspects of the relationship between the variables.

In a first example scenario, the persona input 720 indicates that a “management consultant” style and tone is to be used. In this first example, the presentation LLM 716 generates insight descriptions 718 with a serious tone in the writing style of a management consultant, with the insight descriptions 718 including “No_internet customers are more likely to have a 2-year contract compared to internet customers (30% vs 20%). This may indicate that no_internet customers are more committed to their contracts and are willing to make a longer-term commitment. Internet customers are more likely to have a monthly contract compared to no-internet customers (70% vs 50%). This may indicate that internet customers value the flexibility that comes with a monthly contract.”

In a second example scenario, the persona input 720 indicates that a “MCU comedic” style and tone is to be used. In this second example, the presentation LLM 716 generates insight descriptions 718 with a humorous tone in the writing style of a comedian and analogies made to the Marvel Cinematic Universe, with the insight descriptions 718 including “Looks like internet customers are like Ant-Man®, shrinking away from longer contracts with only 20% opting for a 2 year contract. Just like Iron Man's® suit, internet customers seem to be equipped for short bursts of action, choosing monthly contracts at a rate of 70%.”

In this way, although the underlying data insights may be the same (e.g., in the above examples, the insight descriptions 718 associated with each persona conveys the data insight that 20% of internet customers have a 2 year contract), the insight descriptions 718 differ based on the persona input 720 such that the insight descriptions 718 are generated with different writing styles and tones.

In implementations, the presentation LLM 716 generates chart recommendations 722 corresponding to the insight descriptions 718. The presentation LLM 716 (concurrently with generating the insight descriptions 718, or responsive to a subsequent input of the insight descriptions 718, and so forth) generates a recommended chart type 724 for data associated with the insight description 718. For instance, the chart type 724 is selected from a set of available chart types, such as a bar chart, a donut chart, a table with a heat map, a column chart, a scatter chart, a pie chart, a histogram, and so forth. The presentation LLM 716 also generates chart data 726, by determining data within the data 708 that is pertinent to the insight description 718 and the chart type 724. The chart type 724 and the chart data 726 are collectively referred to as the chart recommendation 722. A chart recommendation 722 may correspond to a singular insight description 718, or may be a singular chart recommendation 722 corresponding to multiple insight descriptions 718.

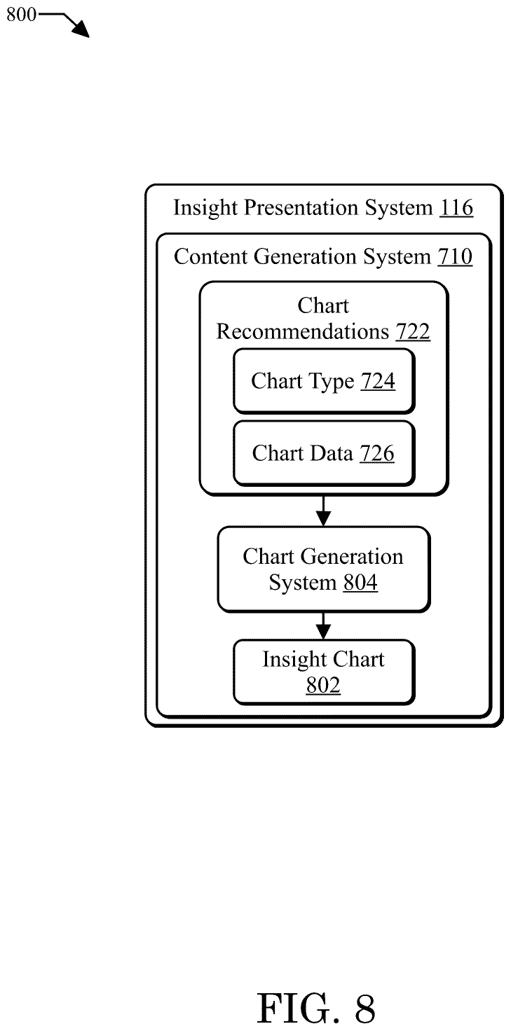

The content generation system 710 inputs the insight descriptions 718 and the chart recommendations 722 into a grouping system 728 to generate a topic 730 that includes the insight 702, as further described below with respect to FIGS. 8-10.

The presentation LLM 716 may output additional content pertaining to the insight 702 or topic 730. For instance, a topic 730 may include multiple insights 702, and the presentation LLM 716 outputs a title describing the topic 730 and a summary that summarizes all insights 702 associated with the topic 730. In implementations, this is performed by utilizing the insights 702 as an input that is fed back into the presentation prompt generation engine 712 or presentation LLM 716 in order to generate the title and summary describing the insights 702 and topic 730.

FIG. 8 depicts a system 800 showing an example chart generation processing pipeline of the content generation system 710 of FIG. 7 in greater detail to create an insight chart 802. The chart generation processing pipeline begins with the chart recommendations 722 of FIG. 7 being input to a chart generation system 804. The chart generation system 804 processes the chart type 724 and the chart data 726 to generate a graphical representation as the insight chart 802. The chart generation system 804, for instance, may be an algorithmic or a machine learning module that determines a layout based on the chart type 724, determines scaling of chart axes based on the chart data 726, generates data labels for the chart based on the chart data 726, populates the chart with data from the chart data 726, and formats the chart with colors, fonts, styles, and so forth in order to create a visual representation of the chart data 726 that is visually appealing and easy to understand.

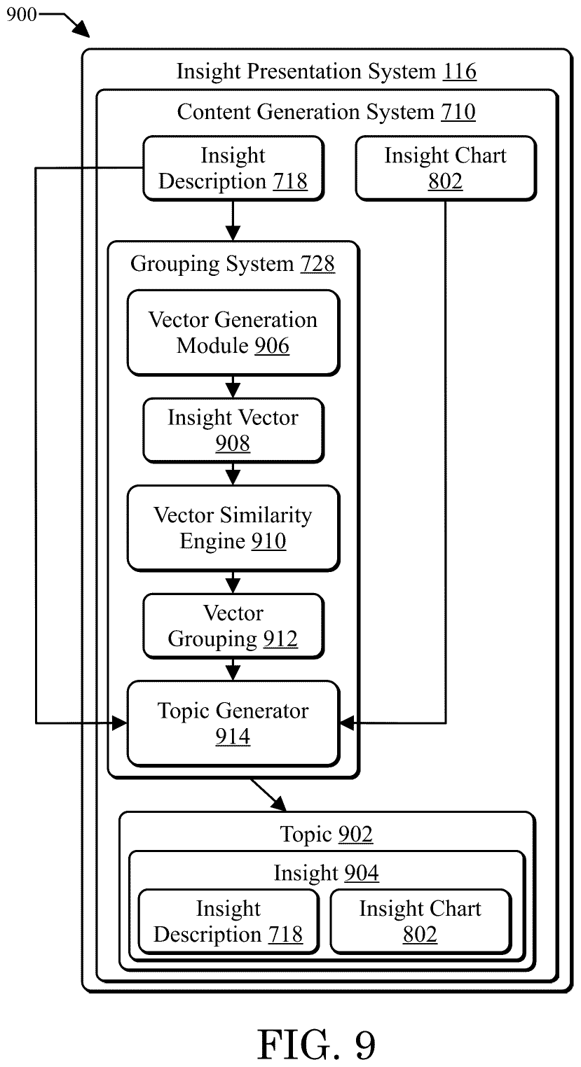

FIG. 9 depicts a system 900 showing an example insight grouping processing pipeline of the content generation system 710 of FIG. 7 in greater detail to create a topic 902 that includes an insight 904. The insight grouping processing pipeline begins with a plurality of insight descriptions 718 being input into the grouping system 728.

The grouping system 728 processes respective ones of the insight descriptions 718 with a vector generation module 906 to generate corresponding insight vectors 908. The vector generation module 906, for instance, is a natural language processing model that captures semantic meaning of the insight description 718. For example, an insight vector 908 may be a numerical representation of text as a vector with one thousand or more dimensions, thereby capable of including significantly more information than is included in raw ASCII values of text features. The vector generation module 906 may be configured in a variety of ways, examples of which include a Global Vectors for word representation model, a Word2Vec model, or any other suitable word embedding model able to create vector representations of words, such as a model that incorporates a recurrent neural network such as a Long Short-Term Memory (LSTM) recurrent neural network.

The vector generation module 906 generates an insight vector 908 for each respective one of the insight descriptions 718. The insight vectors 908 are input to a vector similarity engine 910 configured to group similar insight descriptions 718 based on a measure of distance between corresponding insight vectors 908 in a vector embedding space (e.g., a Euclidean distance, correlation-based distance such as Pearson's correlation or cosine similarity, and so forth). Distance between insight vectors 908 is indicative of similarity between the insight vectors 908, such that insight vectors 908 with a low distance between them have high similarity in contextual and semantic meaning. The vector similarity engine 910, in implementations, utilizes a vector database that includes additional information pertaining to the vector embedding space beyond what is contained within the insight vectors 908 themselves. The vector similarity engine 910 produces a vector grouping 912 that includes an insight vector 908. If the vector similarity engine 910 determines that multiple insight vectors 908 have a sufficient similarity (e.g., distances between vectors are below a threshold value, vectors are included as part of a cluster via a segmentation analysis, and so forth), the similar insight vectors 908 are each assigned to the vector grouping 912. The vector similarity engine 910 may produce a plurality of vector groupings 912, such that each insight vector 908 is associated with a vector grouping 912.

The grouping system 728 inputs the vector groupings 912, the insight descriptions 718, and the insight charts 802 into a topic generator 914 to generate the topics 902. An insight vector 908 in a vector grouping 912 is associated with a corresponding insight description 718 and a corresponding insight chart 802. A respective pair of insight descriptions 718 and insight charts 802 are considered as an insight 904. The topic generator 914 may generate a plurality of insights 904, and each topic 902 contains an insight 904 or multiple insights 904 corresponding to the vector groupings 912 (e.g., each vector grouping 912 is associated with a respective topic 902).

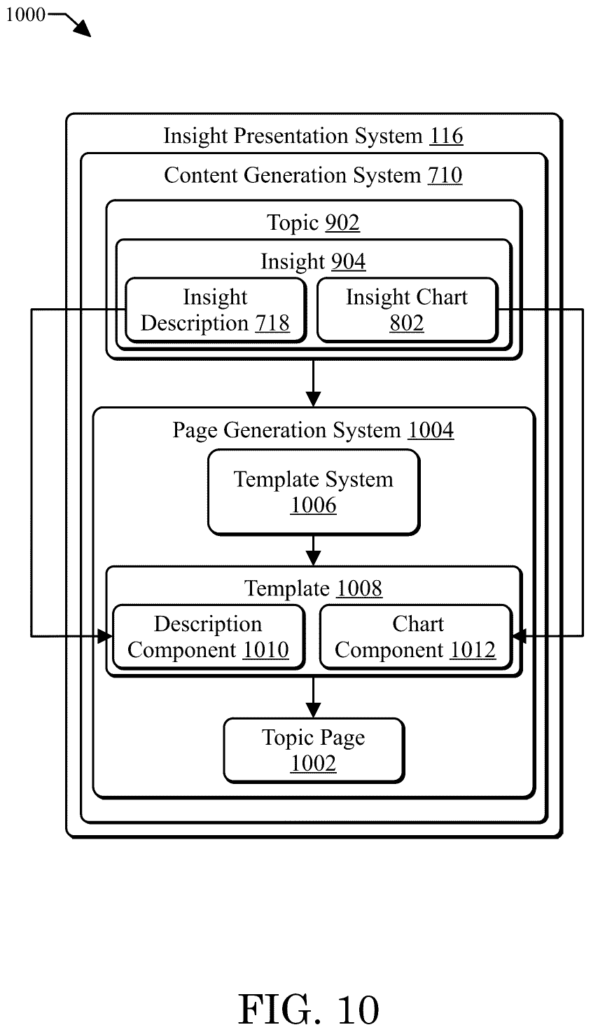

FIG. 10 depicts a system 1000 showing an example page generation processing pipeline of the insight presentation system 116 of FIG. 1 in greater detail to create a topic page 1002. The page generation processing pipeline begins with the topic 902 including insight 904 of FIG. 9 being input to a page generation system 1004.

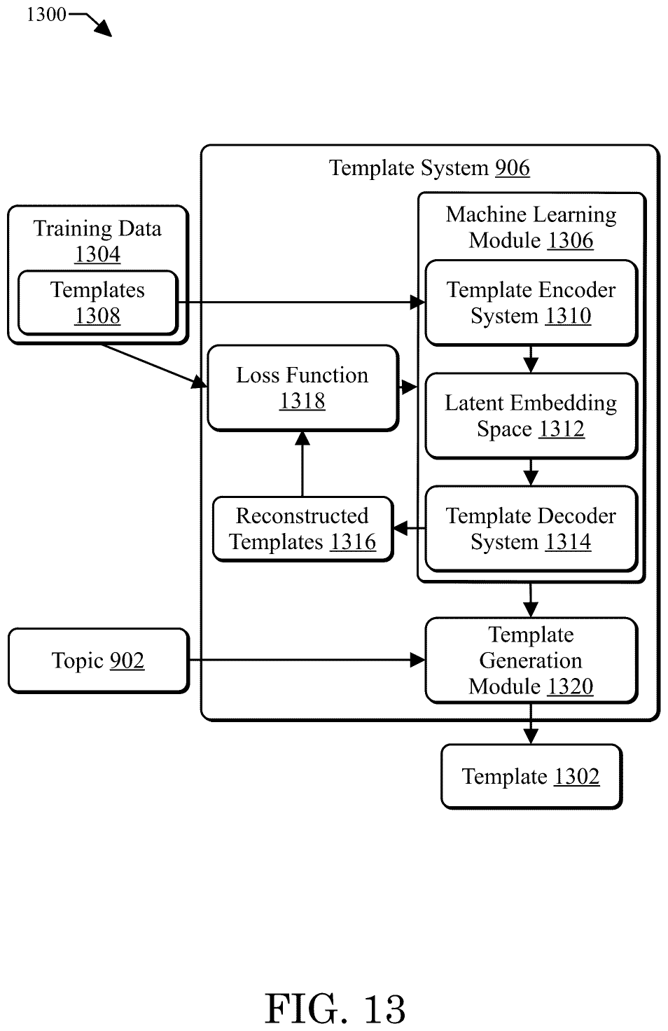

The page generation system 1004 utilizes a template system 1006 to select a template 1008. In implementations, the template system 1006 includes a number of pre-defined templates with specified structures. For instance, the template 1008 includes a description component 1010 and a chart component 1012. Different ones of the pre-defined templates include different numbers of description components 1010 and chart components 1012, each with a pre-determined visual location for each of the description components 1010 and chart components 1012, and may include additional components (e.g., a title component, a summary component, and so forth). In implementations, the template system 1006 is configured to generate a new template 1008 created responsive to an input of the topic 902 as described further below with respect to FIG. 13.

The template system 1006 selects a template 1008, such as by generating a score for each available template (e.g., each of the pre-defined templates, new templates generated by the template system 1006, and so forth). The template system 1006 scores a template by comparing the template with the information in the topic 902. For example, different templates may have different number of chart components, bullet point areas for brief text, text areas for lengthy text, and the template system 1006 may assign a score for each individual element of the template and aggregate the individual component scores to generate a score for the entire template (e.g., a template with a single chart component will receive a higher score if the topic 902 includes a single insight chart 802, while a template with multiple large text areas will receive a lower score if the topic 902 includes only short strings of text, and so forth). The template system 1006 selects a template that has the highest aggregate score as the template 1008.

The page generation system 1004 populates the description component 1010 with the insight description 718, and populates the chart component 1012 with the insight chart 802. This may include, for instance, performing various formatting operations upon the insight description 718 or the insight chart 802 according to preferences or criteria specified by the template 1008. The populated template 1008 is output as the topic page 1002.

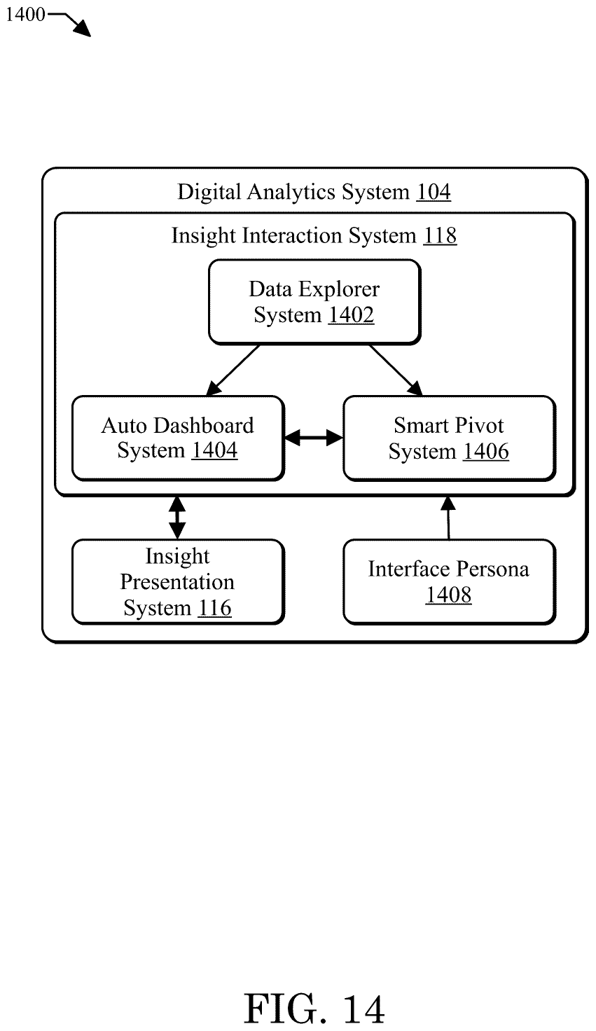

In implementations, the topic page 1002 includes interactive elements, such by configuring the various fields of the topic page 1002 to allow communication with the insight interaction system 118 to further explore the data or view additional insights as described below with respect to FIG. 14, for instance by including an internet link associated with a portion of the topic page 1002 that directs to a webpage associated with the topic page 1002 that is generated by the insight interaction system 118.

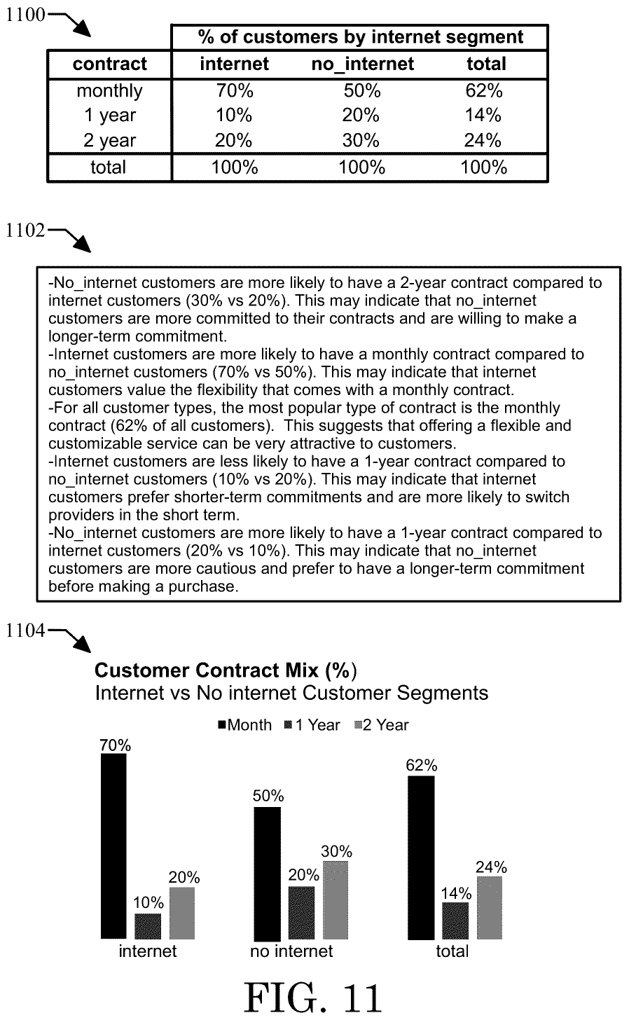

FIG. 11 illustrates an example scenario 1100 depicting a visual example of the data 502 of FIG. 5, an example scenario 1102 depicting a visual example of an insight description 718 of FIG. 7, and an example scenario 1104 depicting a visual example of an insight chart 802 of FIG. 8. In the example scenario 1100, the data 502 includes a table of data describing customers according to contract duration and internet status. In the example scenario 1102, the insight description 718 includes the text “No-internet customers are more likely to have a 2-year contract compared to internet customers (30% vs 20%). This may indicate that no_internet customers are more committed to their contracts and are willing to make a longer-term commitment. Internet customers are more likely to have a monthly contract compared to no_internet customers (70% vs 50%). This may indicate that internet customers value the flexibility that comes with a monthly contract. For all customer types, the most popular type of contract is the monthly contract (62% of all customers). This suggests that offering a flexible and customizable service can be very attractive to customers. Internet customers are less likely to have a 1-year contract compared to no_internet customers (10% vs 20%). This may indicate that internet customers prefer shorter-term commitments and are more likely to switch providers in the short term. No_internet customers are more likely to have a 1-year contract compared to internet customers (20% vs 10%). This may indicate that no_internet customers are more cautious and prefer to have a longer-term commitment before making a purchase.” In the example scenario 1104, the insight chart 802 is illustrated as a visual bar graph showing relative quantities of contract durations for customer segments based on internet status.

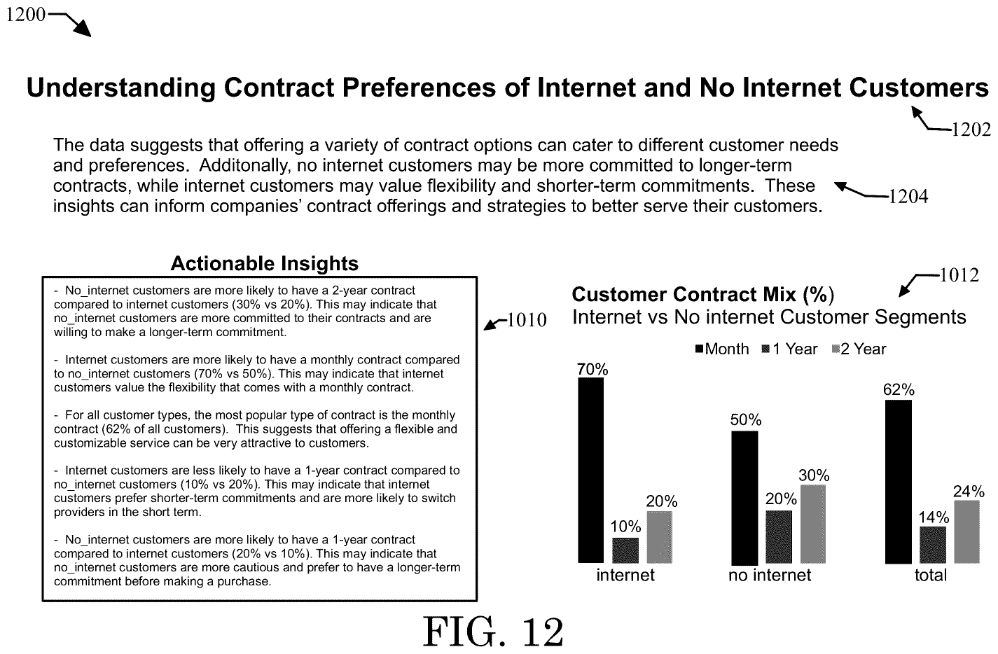

FIG. 12 illustrates a scenario including an example topic page 1200, e.g. as a visual example of the topic page 1002 of FIG. 10. In this example, the page generation system 1004 of FIG. 10 has selected a template 1008 that includes a description component 1010 and a chart component 1012. The page generation system 1004 has populated the description component 1010 with the insight description illustrated in scenario 1102 of FIG. 11, and has populated the chart component 1012 with the chart illustrated in scenario 1104 of FIG. 11, but does not include the table of data illustrated in scenario 1100 of FIG. 11. In this example, the template 1008 further includes a title component 1202 and a summary component 1204. The title component 1202 and the summary component 1204 include information describing the information in the insight description, such as a title and summary generated by the presentation LLM 716 as described above with respect to FIG. 7. In this example, the topic page 1200 is formatted as a presentation slide, e.g., for display by presentation software on computing device 106.

FIG. 13 depicts a system 1300 showing an example machine learning processing pipeline of the template system 1006 of FIG. 10 in greater detail to create a template 1302. The machine learning processing pipeline begins with training data 1304 being input to a machine learning module 1306. The training data 1304 includes templates 1308 that are pre-determined templates, such as described above with respect to template 1008 of FIG. 10. The templates 1308, for instance, include description components, chart components, title components, summary components, and so forth in a particular layout configuration. In implementations, the templates 1308 are configured as slides for display by presentation software.

The templates 1308 are processed by a template encoder system 1310 into data in a latent embedding space 1312. The data in the latent embedding space 1312 is processed by a template decoder system 1314 to create reconstructed templates 1316. The template encoder system 1310 and the template decoder system 1314, for instance, are representative of layers of a neural network with an encoder-decoder architecture to learn image representations of the templates 1308. The machine learning module 1306 further includes a mechanism to compare the reconstructed templates 1316 to the training data 1304 for accuracy, such as by incorporating a loss function 1318. The loss function 1318 is representative of the accuracy of the latent embedding space 1312 and a similarity between the reconstructed templates 1316 and the training data 1304. The loss determined by the loss function 1318 is backpropagated to the template encoder system 1310 and the template decoder system 1314 to change parameters or weights used in generating the reconstructed templates 1316. This process may be repeated many times and with any number of different templates 1308, with a goal of iteratively updating the parameters and weights to minimize the loss from the loss function 1318.

In implementations, the machine learning module 1306 utilizes a generative model architecture such as generative adversarial networks with a generator model and a discriminator model. In these implementations, the template encoder system 1310 and template decoder system 1314 are representative of the generator model, while the loss function 1318 is representative of the discriminator model (e.g., the discriminator model classifies between the reconstructed templates 1316 and the templates 1308 and wrong classifications by the discriminator model are considered a measure of loss, and so forth).

Once the machine learning module 1306 has completed training the model, the last iteration of the model and its parameters or weights are output as the template generation module 1320. The template generation module 1320 incorporates parameters or weights that allow for accurate representation of templates in the latent embedding space 1312. This allows the template generation module 1320 to generate new templates given an input. For instance, the template generation module 1320 may receive a topic 902 as described above with respect to FIGS. 9 and 10 to generate the new template 1302 tailored specifically for the topic 902. The template 1302 may then be utilized by the page generation system 1004 as described above with respect to FIG. 10.

FIG. 14 depicts a system 1400 showing an example environment employing the insight interaction system 118 of the digital analytics system 104 of FIG. 1. The insight interaction system 118 includes a data explorer system 1402, an auto dashboard system 1404, and a smart pivot system 1406. The insight interaction system 118 is communicatively coupled with the insight presentation system 116, such that the insight interaction system 118 may seamlessly access or query the insight presentation system 116, and the insight presentation system 116 may access or query the insight interaction system 118.

The data explorer system 1402 is representative of functionality to access and explore information stored in databases. The data explorer system 1402 provides a user interface to access, connect, or import data in an external database, such as by the insight interaction system communicating with the data storage 102 of FIG. 1 via the network 110. Multiple databases may be connected to the data explorer system 1402, including databases hosted on different computing devices, through different database hosting services, databases with different formats, and so forth. The data explorer system 1402 provides a user interface to organize and explore the various connected databases, and provides functionality to initiate operations by the auto dashboard system 1404, the smart pivot system 1406, or the insight presentation system 116 upon a selected database, grouping of databases, table within a database, grouping of tables within a database, and so forth. As an example, upon selecting a table within a connected database, buttons are provided to directly explore the data within the table, to explore the table with the auto dashboard system 1404, to explore the table with the smart pivot system 1406, and to generate a topic page (e.g., the topic page 1002 of FIG. 10) based on the selected table with the insight presentation system 116.

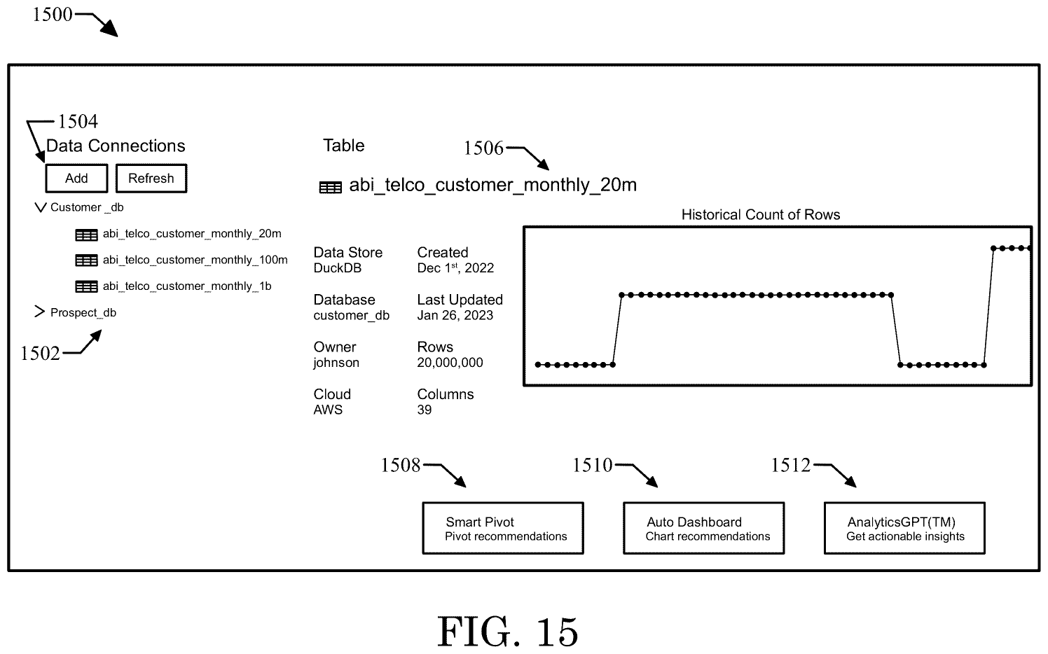

FIG. 15 depicts an example user interface 1500 of the data explorer system 1402, such as a user interface to be provided as part of a webpage for display on the computing device 106. The example user interface 1500 displays connected databases 1502 and a button 1504 to initiate connecting an additional database. The example user interface 1500 further includes a snapshot window 1506 that displays brief metrics and information pertaining to a selected database (or table within a database), such as the name and owner of the database, a data store hosting the database, creation and update dates for the database, a number of rows in the database, a number of columns in the database, and so forth. The example user interface 1500 provides buttons to initiate various functionalities with respect to the selected database, including a button 1508 to access the smart pivot system 1406 of FIG. 14, a button 1510 to access the auto dashboard system 1404 of FIG. 14, and a button 1512 to generate a topic page for the selected table with the insight presentation system 116 as described above.

Returning to FIG. 14, the auto dashboard system 1404 is representative of functionality explore insights pertaining to information stored in databases. For instance, upon connecting a database to data explorer system 1402, the auto dashboard system 1404 automatically inputs the database to the insight generation system 114 to generate topics and insights as described above. The auto dashboard system 1404 sorts, filters, and ranks the topics and insights, and selects a portion of the topics and insights for display in a user interface. For example, the auto dashboard system 1404 generates carousels of charts (e.g., insight charts 802 of FIG. 8) by grouping the charts according to topic (e.g., the topic 902 of FIG. 9) and displaying the charts within respective carousels for their respective topics. Each chart displayed by the auto dashboard system 1404 may be interacted with to initiate further operations, such as to load data associated with the chart into the smart pivot system 1406, generate a topic page that includes the chart by utilizing the insight presentation system 116, and so forth. In this way, a user is provided easy visual access to a variety of automatically generated insights for a database, with a convenient manner to further explore insights of the user's choosing.

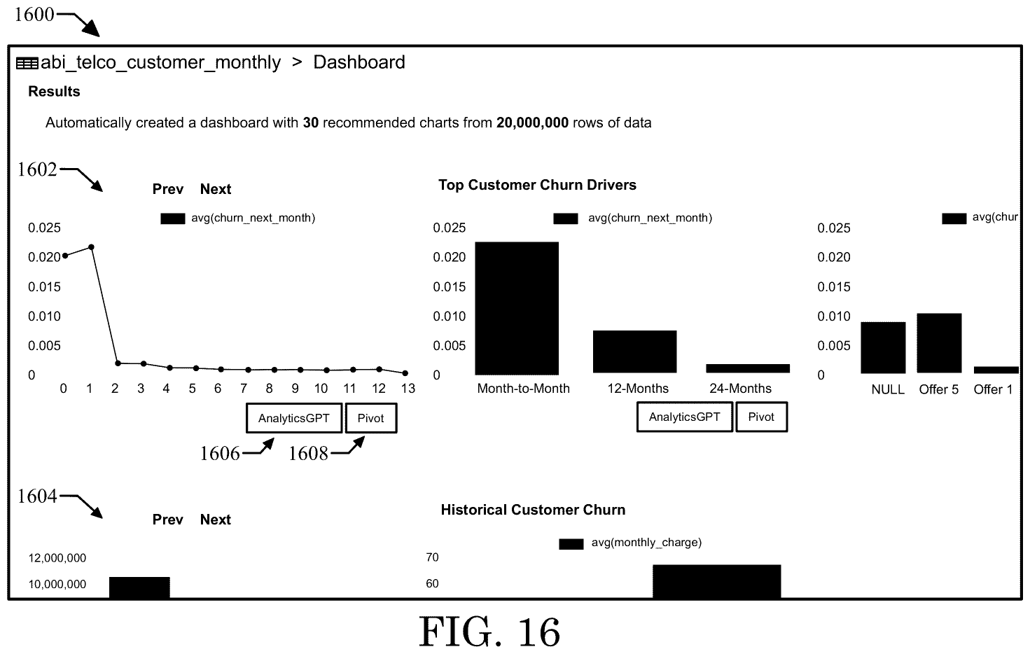

FIG. 16 depicts an example user interface 1600 of the auto dashboard system 1404, such as a user interface to be provided as part of a webpage for display on the computing device 106. The example user interface 1600 displays a chart carousel 1602 associated with a first topic, and a chart carousel 1604 associated with a second topic. In this example, the first topic is “top customer churn drivers” and the second topic is “historical customer churn”. Each of the chart carousels in this example displays three charts, however a user may interact with the carousel to scroll left or right through the carousel to reveal additional charts (e.g., the carousel may be conceptualized as a three dimensional wheel with charts on the outside of the wheel, such that only a portion of the outside of the wheel is visible at a time, with scrolling in the user interface analogous to spinning the three dimensional wheel to view different portions of the outside of the wheel). The digital carousel, however, may be interactively sized to accommodate any arbitrary number of charts, and the user interface may configured to simultaneously display any arbitrary number of charts within a carousel. Each chart within the chart carousels is associated with a respective button 1606 to utilize the insight presentation system 116 to generate a corresponding topic page, and a respective button 1608 to load data associated with the chart into the smart pivot system 1406.

Returning to FIG. 14, the smart pivot system 1406 is representative of functionality to interactively explore information stored in databases. The smart pivot system 1406 is configured to generate a pivot table for information within a database, with interactive fields that allow real-time or near real-time alterations to the pivot table. For instance, the smart pivot system 1406 provides field cards that are drag-and-drop elements corresponding to individual fields within the database, allowing a user to easily drag a particular field to be used as a filter, a column, a row, or as values within the pivot table. The field cards include visual displays of data distribution within the respective field in the database, along with metadata for the respective field such as a recommendation score, data quality metrics, and so forth.

The smart pivot system 1406 generates and displays recommendation scores for each field card that change based on a current configuration of the pivot table. For instance, the recommendation score may indicate an expected change to an amount of ‘insightfulness’ of the pivot table if the corresponding field card were to be added to the pivot table. In implementations, the smart pivot system 1406 generates an insightfulness score for every possible combination of fields in the database (e.g., by generating insights with the insight generation system 114 and comparing a number of insights that incorporate each combination of fields). The recommendation score associated with a particular field card may then be an indication of how insightful the resulting pivot table will be if the particular field card is added. In this way, the recommendation score may change each time a user interacts with the smart pivot system 1406. For example, as a user drags a field card to incorporate it into the pivot table, the recommendation score for each remaining field card is updated to reflect its utility or insightfulness specifically in combination with the newly selected field card. In this way, the smart pivot system 1406 is able to dynamically recommend particular fields for use in a pivot table and guide a user in selection of fields, while allowing the user to retain full control over which fields are ultimately selected.

In implementations, the smart pivot system 1406 generates a data quality score or alert in associate with particular field cards. As an example, a data quality alert may be displayed on a field card as “high null %” based on a large percentage of values in that field being null in the database. This allows a user to easily see that although a particular field may otherwise be valuable, utilizing that field in further analysis may lead to unreliable results until further data is acquired for that field. However, the decision to use or not use that field remains in control of the user of the smart pivot system 1406.

As field cards or added or removed, the smart pivot system 1406 dynamically generates, formats, and adjusts the pivot table to incorporate the changes. The smart pivot system 1406 may further automatically generate and format a chart based on the pivot table, such as by utilizing the chart generation system 804 of FIG. 8. In implementations, the smart pivot system 1406 may generate and display the SQL code used for a particular pivot table to retrieve the data from a database. This provides a user of the smart pivot system 1406 visibility into the data used in the pivot table, allows the user to copy or save the code for future use (e.g., the user may manually execute the code directly upon a database at a future point in time without accessing the smart pivot system 1406 again), adjust the code for use on a similar database (e.g., to create corresponding pivot tables from other tables in a database or other databases with a similar format), and so forth.

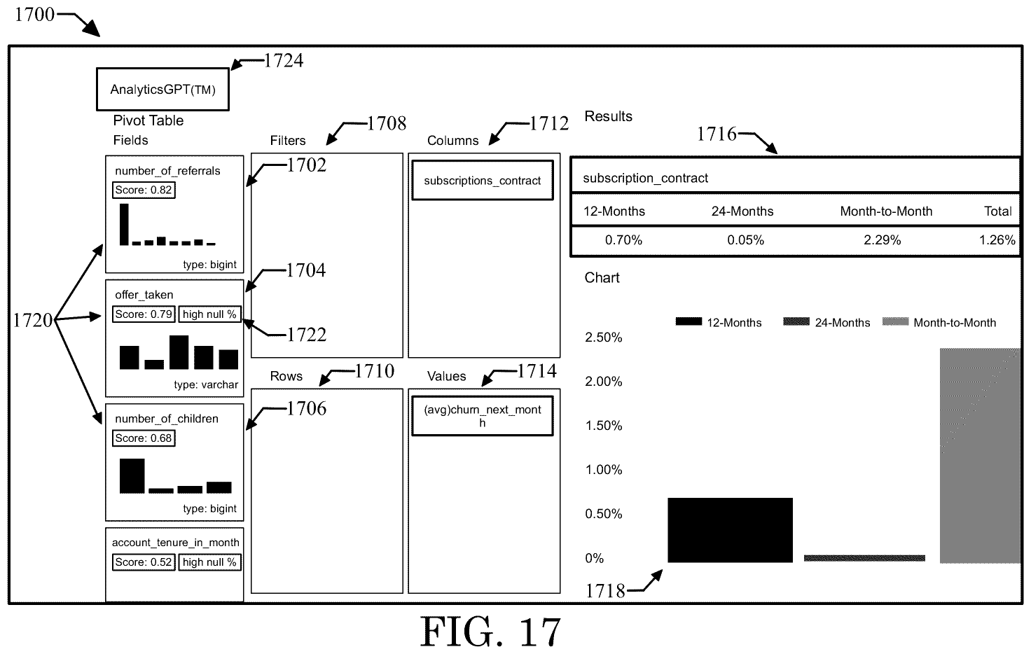

FIG. 17 depicts an example user interface 1700 of the smart pivot system 1406, such as a user interface to be provided as part of a webpage for display on the computing device 106. The user interface 1700 includes field cards 1702, 1704, and 1706. In this example, field card 1702 is associated with a “number of referrals” field of a table within a database, field card 1704 is associated with an “offer_taken” field of the table, and the field card 1706 is associated with a “number of children” field of the table. Each of the field cards 1702, 1704, and 1706 is an interactive UI element of the user interface 1700, such as being ‘draggable’ to be ‘dropped’ into other UI elements of the user interface 1700. The user interface 1700 includes a filters element 1708, a rows element 1710, a columns element 1712, and a values element 1714, each of which is configured to receive field cards. In this example, a field card associated with a “subscription_contract” field of the table has been dragged into the columns element 1712, and a field card associated with a “churn_next_month” field of the table has been dragged into the values element 1714.

The user interface 1700 includes a pivot table 171 and a chart 1718. The smart pivot system 1406 has created a pivot table 1716 with data from the database that compares “subscription_contract” data with “churn_next_month” data, and the smart pivot system 1406 has further created a chart 1718 that visually represents the data in the pivot table 1716. As a user of the smart pivot system 1406 has dragged “subscription_contract” into the columns element 1712, the columns of the pivot table 1716 pertain to the “subscription_contract” data, in this case showing columns for 12-months, 24-months, and month-to-month, each of which is a type of subscription contract length described by the “subscription_contract” data. The user of the smart pivot system 1406 has also dragged “churn_next_month” into the values element 1714, and the pivot table 1716 is configured such that the displayed values are churn rates according to subscription contract types. The chart 1718 illustrates the data in the pivot table 1716, and in this example includes a bar graph with bars of subscription contract types scaled according to an x-axis of churn rates.

The field cards 1702, 1704, and 1706 each include a recommendation score 1720. The recommendation score 1720 is a respective numerical value for the respective field card that indicates a relative value of adding the respective field card to one of the filters element 1708, the rows element 1710, the columns element 1712, and the values element 1714. The recommendation scores 1720 are dynamically updated whenever a field card is moved, such that the recommendation scores 1720 displayed in the illustrated example user interface 1700 are specific to the scenario in which the “subscription_contract” card is in the columns element 1712 and the “churn_next_month” card is in the values element 1714. The field card 1704 further includes a data quality alert 1722, which in this case displays “high null %” which indicates that the “offer_taken” field of the table includes a large number of null values.

The example user interface 1700 further includes a button 1724 which initiates processes by the insight presentation system 116 to generate a topic page (e.g., the topic page 1002 of FIG. 10) based on the field cards currently located in the filters element 1708, the rows element 1710, the columns element 1712, and the values element 1714.

In implementations, the insight interaction system 118 employs an interface persona 1408. The interface persona 1408 is an AI persona generated with a biography, personality and face. The interface persona 1408 is created using generative machine learning models, such that the persona has an associated personality and style. The interface persona 1408 is provided by the insight interaction system 118 as a means of interacting with the insight interaction system 118, e.g., as an additional output or a modification of output of the insight interaction system 118. In an example, input to the insight interaction system 118 is provided as part of a conversation with the interface persona 1408, and output of the insight interaction system 118 outputs includes a video of the interface persona 1408 (e.g., with a face and a voice associated with the interface persona) that audibly explains output information. In this way, the interface persona 1408 enables interaction between a user of the insight interaction system 118 and the insight interaction system 118 to mimic human-human interactions.

A user of the insight interaction system 118 may select an interface persona 1408 from among a list of available interface personas. For example, the insight interaction system 118 may include an interface persona for “Amanda Bain, Consultant”, “Troy Murphy, Marketing Director”, “Sarah Lee, Product Manager”, “Ben Patterson, Software Engineer”, “Ron Giggles, Comedian”, and so forth. Each of the interface personas has a respective personality and style. For instance, the interface personas 1408 may correspond to the persona inputs 720 of FIG. 7.

In implementations, the interface persona 1408 affects not only the video output of the insight interaction system 118, but affects all output of the insight presentation system 116 and the insight interaction system 118, similar to the techniques described above wherein the persona input 720 of FIG. 7 alters the content generated by the content generation system 710. The interface persona 1408 selected in the insight interaction system 118, for instance, may be automatically applied as the persona input 720 to the content generation system 710. For example, the interface persona of “Ron Giggles, Comedian” tells a joke after every data analysis, the interface persona of “Amanda Bain, Consultant” structures information in a professional manner with no extraneous language provided, and the interface persona of “Ben Patterson, Software Engineer”, structures responses with an extra emphasis on code used in retrieving and analyzing data, the interface persona of “Troy Murphy, Marketing Director” provides a marketing recommendation based on prescriptive analytics alongside every data analysis, and so forth. The video outputs of the interface personas 1408 are configured to appear as if a person is speaking, such as with a generated face and generated audio that correspond to the respective interface persona 1408.

The digital analytics system 104 provides for cross-interaction among the insight generation system 114, the insight presentation system 116, and the insight interaction system 118. For instance, a topic page generated by the insight presentation system 116 may include links or other functionalities to access associated data with the insight interaction system 118. As an example, an insight description in the topic page can be interacted with to explore the data used to generate the insight description in the insight interaction system 118, an insight chart in the topic page can be interacted with to access the smart pivot system 1406 and auto-populate a pivot table with the data displayed by the insight chart, and so forth. Similarly, data and charts displayed in the data explorer system 1402, the auto dashboard system 1404, or the smart pivot system 1406 may include functionality to generate topic pages with the insight presentation system 116 for the respective data or charts.

In implementations, the classifier prompt generation engine 208 of FIG. 2, the code prompt generation engine 514 of FIG. 5, and the presentation prompt generation engine 712 of FIG. 7 are each independent engines trained individually for their respective tasks. In other implementations, the classifier prompt generation engine 208 of FIG. 2, the code prompt generation engine 514 of FIG. 5, and the presentation prompt generation engine 712 of FIG. 7 are trained as a single prompt generation engine trained to perform all of the tasks of the individual prompt generation engines. Similarly, in implementations, the classifier LLM 212 of FIG. 2, the code LLM 516 of FIG. 5, and the presentation LLM 716 of FIG. 7 are each independent LLMs trained individually for their respective tasks. In other implementations, the classifier LLM 212, the code LLM 516, and the presentation LLM 716 are trained as a single LLM trained to perform all of the tasks of the individual LLMs. Further, in implementations, the prompt generation engines may be incorporated as part of an LLM, such as by utilizing a prompt chain where the output of an LLM is used as an input to the LLM (e.g., the LLM generates a prompt based on an input, and the generated prompt is input back into the same LLM to generate an output, and so forth). For example, with respect to FIG. 5, the selected task 506 and the user input 508 may be input to the code LLM 516 to generate the code prompt 518, and the code prompt 518 is input into the code LLM 516 to generate the code 522, thus incorporating the functionalities of the code prompt generation engine 514 into the code LLM 516.

### Example Procedures

The following discussion describes techniques that may be implemented utilizing the previously described systems and devices. Aspects of the procedures may be implemented in hardware, firmware, software, or a combination thereof. The procedures are shown as sets of blocks that specify operations performed by one or more devices and are not necessarily limited to the orders shown for performing the operations by the respective blocks. In portions of the following discussion, reference will be made to FIGS. 1-17.

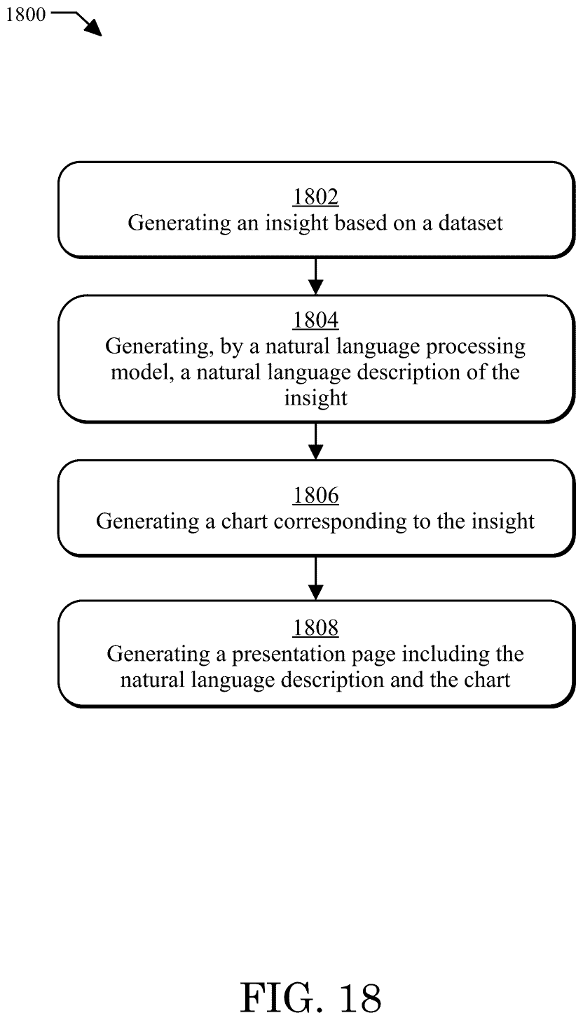

FIG. 18 depicts a procedure 1800 in an example implementation of data insight generation and presentation. An insight is generated based on a dataset (block 1802). For instance, a user input is received that indicates a business question or request with respect business data stored in a database. A machine learning model processes the user input to understand the intent of the query, such as to determine an appropriate data analysis task that is best suited to answer the query (e.g., the task classifier 206 as described with respect to FIG. 2). A machine learning model processes the data analysis task along with the user input in order to determine what data is relevant in conducting the data analysis, and the database is queried to retrieve a dataset including the data (e.g., the data extraction system 510 as described with respect to FIG. 5). A machine learning model then processes the dataset along with the user input to perform the data analysis task. The results of the data analysis task are parsed to determine particular results that are insightful, interesting, or salient, and these particular results are considered the insight.

A natural language description of the insight is generated by a natural language processing model (block 1804). A machine learning model processes the insight to output a natural language description of the insight, such as a natural language description that includes additional information or context to aid a user in easily understanding or interpreting the insight (e.g., the content generation system 710 as described with respect to FIG. 7).

A chart is generated corresponding to the insight (block 1806). Data associated with the insight is processed by an algorithmic or machine learning module to determine a chart type and chart layout best suited for the data, and creates a chart that portrays a visual representation of the insight (e.g., the chart generation system 804 as described with respect to FIG. 8).

A presentation page that includes the natural language description and the chart is generated (block 1808). The presentation page, for instance, is a PowerPoint® compatible presentation slide, and includes a title, a summary of the insights, a bullet point listing of the natural language descriptions of the insights, and a chart(s) visualizing the relevant data associated with the insights. The presentation page is generated by locating or generating a presentation page template that is suitable for the types and quantity of natural language descriptions and charts, and populating the presentation page template with the relevant information (e.g., the page generation system 1004 as described with respect to FIG. 10). The presentation page may be associated with a particular topic, and may include multiple insights pertaining to the topic (e.g., with insights associated to topics by the grouping system 728 as described with respect to FIG. 9). The presentation page may include functionality to interact with an insight interaction system (e.g., the insight interaction system 118 as described with respect to FIGS. 14-17), such as with a data explorer system, an auto dashboard system, a smart pivot system, and so forth. For example, the presentation page may be configured to include a component with an embedded link to a website associated with the insight interaction system (e.g., configured such that double-clicking on a chart on the presentation page will open a webpage).

Having discussed some example procedures, consider now a discussion of an example system and device in accordance with one or more implementations.

### Example System and Device

FIG. 19 illustrates an example system generally at 1900 that includes an example computing device 1902 that is representative of one or more computing systems and/or devices that may implement the various techniques described herein. This is illustrated through inclusion of the digital analytics system 104. The computing device 1902 may be, for example, a server of a service provider, a device associated with a client (e.g., a client device), an on-chip system, and/or any other suitable computing device or computing system.

The example computing device 1902 as illustrated includes a processing system 1904, one or more computer-readable media 1906, and one or more I/O interface 1908 that are communicatively coupled, one to another. Although not shown, the computing device 1902 may further include a system bus or other data and command transfer system that couples the various components, one to another. A system bus can include any one or combination of different bus structures, such as a memory bus or memory controller, a peripheral bus, a universal series bus, and/or a processor or local bus that utilizes any of a variety of bus architectures. A variety of other examples are also contemplated, such as control and data lines.

The processing system 1904 is representative of functionality to perform one or more operations using hardware. Accordingly, the processing system 1904 is illustrated as including hardware element 1910 that may be configured as processors, functional blocks, and so forth. This may include implementation in hardware as an application specific integrated circuit or other logic device formed using one or more semiconductors. The hardware elements 1910 are not limited by the materials from which they are formed or the processing mechanisms employed therein. For example, processors may be comprised of semiconductor(s) and/or transistors (e.g., electronic integrated circuits). In such a context, processor-executable instructions may be electronically-executable instructions.

The computer-readable storage media 1906 is illustrated as including memory/storage 1912. The memory/storage 1912 represents memory/storage capacity associated with one or more computer-readable media. The memory/storage component 1912 may include volatile media (such as random access memory) and/or nonvolatile media (such as read only memory, Flash memory, optical disks, magnetic disks, and so forth). The memory/storage component 1912 may include fixed media (e.g., RAM, ROM, a fixed hard drive, and so on) as well as removable media (e.g., Flash memory, a removable hard drive, an optical disc, and so forth). The computer-readable media 1906 may be configured in a variety of other ways as further described below.

Input/output interface(s) 1908 are representative of functionality to allow a user to enter commands and information to computing device 1902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module”, “functionality”, and “component” as used herein generally represent software, firmware, hardware, or a combination thereof. The features of the techniques described herein are platform independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1902. By way of example, and not limitation, computer-readable media includes “computer-readable storage media” and “computer-readable signal media”.

“Computer-readable storage media” refers to media and/or devices that enable persistent and/or non-transitory storage of information in contrast to mere signal transmission, carrier waves, or signals per se. Thus, computer-readable storage media refers to non-signal bearing and non-transitory media. The computer-readable storage media includes hardware such as volatile and non-volatile, removable and nonremovable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, Flash memory, CD-ROM, DVD or other optical storage, hard disks, magnetic cassettes, magnetic tape, magnetic disk storage or other magnetic storage devices, or other storage devices, tangible media, or article of manufacture suitable to store the desired information and which may be accessed by a computer.

“Computer-readable signal media” refers to a signal-bearing medium that is configured to transmit instructions to the hardware of the computing device 1902, such as via a network. Computer-readable signal media may embody computer readable instructions, data structures, program modules, or other data in a modulated data signal, such as carrier waves, data signals, or other transport mechanisms. Computer-readable signal media also includes any information delivery media. The term “modulated data signal” means a signal that has one or more of its characteristics set or changed in such a manner as to encode information in the signal. By way of example, and not limitation, communication media includes weird media such as a wired network or direct-wired connection, and wireless media such as acoustic, RG, infrared, and other wireless media.

As previously described, hardware elements 1910 and computer-readable media 1906 are representative of modules, programmable device logic and/or fixed device logic implemented in a hardware form that may be employed in some embodiments to implement at least some aspects of the techniques descried herein, such as to perform one or more instructions. Hardware may include components of an integrated circuit or on-chip system, and application-specific integrated circuit, a field-programmable gate array, a complex programmable logic device, and other implementations in silicon or other hardware. In this content, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1910. The computing device 1902 may be configured to implement particular instructions and/or functions corresponding to the software and/or hardware modules. Accordingly, implementation of a module that is executable by the computing device 1902 as software may be achieved at least partially in hardware, e.g., through use of computer-readable storage media and/or hardware elements 1910 of the processing system 1904. The instructions and/or functions may be executable/operable by one or more articles of manufacture (for example, one or more computing devices 1902 and/or processing systems 1904) to implement techniques, modules, and examples described herein.

The techniques described herein may be supported by various configurations of the computing device 1902 and are not limited to the specific examples of the techniques described herein. This functionality may also be implemented all or in part through use of a distributed system, such as over a “cloud” 1914 via a platform 1916 as described below.

The cloud 1914 includes and/or is representative of a platform 1916 for resources 1918. The platform 1916 abstracts underlying functionality of hardware (e.g., servers) and software resources of the cloud 1914. The resources 1918 may include applications and/or data that can be utilized while computer processing is executed on servers that are remote from the computing device 1902. Resources 1918 can also include services provided over the Internet and/or through a subscriber network, such as a cellular or Wi-Fi network.

The platform 1916 may abstract resources and functions to connect the computing device 1902 with other computing devices. The platform 1916 may also serve to abstract scaling of resources to provide a corresponding level of scale to encountered demand for the resources 1918 that are implemented via the platform 1916. Accordingly, in an interconnected device embodiment, implementation of functionality described herein may be distributed throughout the system 1900. For example, the functionality may be implemented in part on the computing device 1902 as well as via the platform 1916 that abstracts the functionality of the cloud 1914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method for insight generation and presentation, implemented by at least one computing device, the method comprising:
generating, by the at least one computing device, an insight based on a dataset, the insight describing a relationship between variables in the dataset;
generating, by a natural language processing model of the at least one computing device, a natural language description of the insight;
generating, by the at least one computing device, a chart corresponding to the insight; and
generating, by the at least one computing device, a presentation page including the natural language description and the chart, the presentation page configured for display in a user interface of a client device.

2. The method of claim 1, wherein:
the generating an insight includes generating a plurality of insights;
the generating a natural language description includes generating a plurality of natural language descriptions, each respective natural language description corresponding to a respective one of the plurality of insights;
the generating a chart includes generating a plurality of charts, each respective chart corresponding to a respective one of the plurality of insights; and
the presentation page includes at least one of the plurality of natural language descriptions and at least one of the plurality of charts.

3. The method of claim 1, wherein the generating the insight includes extracting the dataset from a database by generating code with a machine learning module and executing the code upon the database.

4. The method of claim 3, wherein the code is displayed in the user interface.

5. The method of claim 1, wherein the generating the natural language description includes:
generating a presentation prompt with a machine learning module; and
processing the presentation prompt with the natural language processing model.

6. The method of claim 1, wherein the generating the natural language description includes processing the insight and a persona with the natural language processing model to generate the natural language description in a language style corresponding to the persona.

7. The method of claim 6, further comprising:
maintaining a plurality of personas, each respective one of the plurality of personas associated with a respective language style;
receiving a user input indicating the persona from among the plurality of personas.

8. The method of claim 2, further comprising:
determining, by a machine learning model, a topic associated with at least two of the plurality of natural language descriptions; and
wherein the presentation page is associated with the topic and includes the at least two of the plurality of natural language descriptions associated with the topic.

9. The method of claim 8, wherein the determining the topic includes:
generating, for each of the plurality of natural language descriptions, a respective word embedding vector;
determining a grouping of word embedding vectors in a vector embedding space; and
associating each respective word embedding vector in the grouping with the topic.

10. The method of claim 1, wherein the generation the presentation page includes:
selecting a presentation template, the presentation template including a description component and a chart component;
populating the description component with the natural language description; and
populating the chart component with the chart.

11. The method of claim 10, wherein the template is generated by a machine learning model with a latent embedding space representative of image representations of presentation templates, the latent embedding space learned from an encoder-decoder machine learning architecture.

12. The method of claim 1, wherein the presentation page includes an interactive component for interaction in the user interface, the interactive component configured to access a pivot table associated with the insight.

13. At least one computing device in a digital medium environment for insight generation and presentation, the at least one computing device including a processing system and at least one computer-readable storage medium, the at least one computing device comprising:
a large language model configured to:
receive a dataset;
generate an insight based on the dataset;
generate a natural language description of the insight;
generate a presentation page including the natural language description and
a chart corresponding to the insight, the presentation page configured for display in
a user interface of a client device; and
a trained machine learning model configured to generate the chart based on the insight.

14. The at least one computing device of claim 13, wherein the large language model is further configured to:
receive a user input, wherein the generating an insight is based on the user input; and
determine a task associated with the user input, wherein the generating the insight is based on the task.

15. The at least one computing device of claim 13, wherein the large language model is further configured to:
generate code configured to extract the dataset from a database; and
communicate the code for display in the user interface of the client device.

16. The at least one computing device of claim 13, wherein the generating the natural language description includes receiving a user input indicating a persona representative of a language style, and wherein the natural language description incorporates the language style.

17. A computing device comprising:
one or more processors; and
one or more computer-readable storage media storing processor-executable instructions that, responsive to execution by the one or more processors, cause the system to perform operations including:
receiving a dataset;
generating a plurality of data aggregations based on the dataset;
generating a prompt based on the plurality of data aggregations and a user input;
generating, with a large language model, a plurality of insight descriptions corresponding to respective ones of the plurality of data aggregations;
generating, with a trained machine learning model, a chart based on the plurality of insight descriptions; and
generating, with the large language model, a presentation page including the plurality of insight descriptions and the chart, the presentation page configured for display in a user interface of a client device; and
communicating the presentation page to the client device.

18. The computing device of claim 17, wherein the generating the plurality of data aggregations is performed prior to receiving the user input.

19. The computing device of claim 17, wherein the presentation page further includes a title representative of the plurality of insight descriptions and a summary of the plurality of insight descriptions.

20. The computing device of claim 17, wherein the operations further include generating a topic by converting the plurality of insight descriptions into respective vector representations, grouping a subset of the vector representations into a similarity group based on distance between the vector representations, and generating a topic that includes respective ones of the plurality of insight descriptions corresponding to respective vector representations in the subset of the vector representations, and wherein the presentation page includes the topic.
